(19) United States
(12) Patent Application Publication
(10) Pub. No.: US 2019/0372119 A1
(43) Pub. Date: Dec. 5, 2019

(54) POSITIVE ELECTRODE ACTIVE MATERIAL FOR NON-AQUEOUS ELECTROLYTE SECONDARY BATTERY AND NON-AQUEOUS ELECTROLYTE SECONDARY BATTERY

(71) Applicants: SUMITOMO METAL MINING CO., LTD., Tokyo (JP); TOYOTA JIDOSHA KABUSHIKI KAISHA, AICHI (JP)

(72) Inventors: Takahiro TOMA, EHIME (JP); Taira AIDA, EHIME (JP); Tetsufumi KOMUKAI, EHIME (JP); Ryuta SUGIURA, AICHI (JP)

(21) Appl. No.: 16/461,887

(22) PCT Filed: Nov. 22, 2017
(86) PCT No.: PCT/JP2017/042048

§ 371 Date: May 17, 2019

(30) Foreign Application Priority Data
Nov. 22, 2016 (JP) 2016-226873

(51) Int. Cl. H01M 4/525; H01M 4/505; H01M 4/36; H01M 10/0525; C01G 53/00

(52) U.S. Cl. CPC H01M 4/525; H01M 4/505; H01M 2004/028; H01M 10/0525; C01G 53/50; H01M 4/366

(57) ABSTRACT

A positive electrode active material for a non-aqueous electrolyte secondary battery that can improve the output characteristics without deteriorating its battery capacity and cycling characteristics. The positive electrode active material comprises a lithium transition metal-containing composite oxide comprising secondary particles that are constructed by an aggregation of a plurality of primary particles. The secondary particles comprise an outer shell section where the primary particles are aggregated, a center section constructed by an inner space existing inside the outer shell section, and at least one through-hole formed in the outer shell section and communicating the center section and outside, and the ratio of the inner diameter of the through-hole with respect to the thickness of the outer shell section is 0.3 or more.

### TECHNICAL FIELD

The present invention relates to a positive electrode active material for a non-aqueous electrolyte secondary battery and a non-aqueous electrolyte secondary battery.

### BACKGROUND ART

In recent years, with the spread of portable electronic devices such as portable telephones, notebook personal computers and the like, there is a large need for development of compact and lightweight secondary batteries having a high energy density. Moreover, there is a large need for high-output secondary batteries as the power source for electric cars such as hybrid electric vehicles, plug-in hybrid electric vehicles, and battery-powered electric vehicles.

As a secondary battery that satisfies such a demand, there is a lithium-ion secondary battery that is one kind of a non-aqueous electrolyte secondary battery. This lithium-ion secondary battery includes a negative electrode, a positive electrode, an electrolyte and the like; and an active material capable of insertion/de-insertion of lithium is used as the material for the negative electrode and positive electrode.

Currently the research and development is actively performed for a lithium-ion secondary battery in which a lithium transition metal-containing composite oxide having a layered rock-salt type or spinel type crystal structure is used as the positive electrode material, which is capable of obtaining a high 4 volt class voltage and thus has a high energy density, and the practical use is partially advanced.

As a positive electrode active material for a non-aqueous electrolyte secondary battery that is the positive electrode material for this lithium-ion secondary battery, lithium composite oxides such as lithium cobalt composite oxide (LiCoO₂) which is synthesizable comparatively easily, lithium nickel composite oxide (LiNiO₂) in which nickel that is less expensive than cobalt is used, lithium nickel cobalt manganese composite oxide (LiNi_{1/3}Co_{1/3}Mn_{1/3}O₂), lithium manganese composite oxide (LiMn₂O₄) that uses manganese, lithium nickel manganese composite oxide (LiNi_{0.5}Mn_{0.5}O₂), and the like are proposed.

Here, in order to obtain a lithium-ion secondary battery having excellent cycling characteristics and output characteristics, it is required that the positive electrode active material for a non-aqueous electrolyte secondary battery is formed from particles having a small diameter and a narrow particle size distribution. This is because particles having a small diameter have a large specific surface area so that it is possible to sufficiently maintain the reaction surface area with the electrolyte, as well as to form the positive electrode to be thin, thereby reduce the positive electrode resistance by shortening the moving distance of the lithium ions between the positive electrode and negative electrode. This is also because, in the particles having a narrow particle size distribution, the voltage applied to each particle within the electrode is almost constant so that it is possible to suppress deterioration of the battery capacity due to selective degradation of the fine particles.

In order to further improve the output characteristics, it is efficient to form a hollow space section inside the particles of the positive electrode active material for a non-aqueous electrolyte secondary battery where the electrolyte can enter. The positive electrode active material for a non-aqueous electrolyte secondary battery, which has a hollow structure comprising an outer shell section and a hollow space section located inside the outer shell section, is able to largely reduce the positive electrode resistance as it is possible to enlarge the reaction area with the electrolyte compared to the positive electrode active material for a non-aqueous electrolyte secondary battery having a solid structure which has about the same particle size. It is known that the positive electrode active material for a non-aqueous electrolyte secondary battery takes over the particle properties of the transition metal-containing composite hydroxide which is the precursor thereof.

For example, JP2012-246199 (A), JP2013-147416 (A), and WO2012/131881 disclose a method for manufacturing a transition metal-containing composite hydroxide that is a precursor of a positive electrode active material by separating a crystallization reaction into two steps, namely a nucleation step where nucleation is mainly performed, and a particle growth step where particle growth is mainly performed. In this method, by suitably adjusting the pH value and the reaction atmosphere in the nucleation step and the particle growth step, a transition metal-containing composite hydroxide being constructed by secondary particles, which has a small particle size and a narrow particle size distribution, as well as comprising a low density center section being composed of fine primary particles and a high density outer shell section which is comprised of plate-shaped primary particles, is obtained.

The positive electrode active material for a non-aqueous electrolyte secondary battery obtained using a transition metal-containing composite hydroxide of such structure as a precursor thereof has a small particle size and a narrow particle size distribution, and can comprise a hollow structure provided with an outer shell section and a hollow space section located inside thereof. Therefore, in the secondary battery using these positive electrode active materials for a non-aqueous electrolyte secondary battery, it is considered that the battery capacity, output characteristics, and cycling characteristics will be improved at the same time.

JP2011-119092 (A) discloses a lithium transition metal-containing composite oxide having a perforated hollow structure comprising secondary particles that are formed by an aggregation of a plurality of primary particles and has an outer shell section, a hollow space section located inside the outer shell section, and a through-hole that passes through from the outside space to the hollow space section, in order to provide a positive electrode active material which exhibits characteristics suitable for high output of a non-aqueous electrolyte secondary battery and with less deterioration in the charge/discharge cycling characteristics. It is supposed that the positive electrode active material having such a perforated hollow structure is able to further reduce the positive electrode resistance and improve its output characteristics.

### PRIOR ART DOCUMENTS

### Patent Documents

Patent Document 1: JP2012-246199 (A)
Patent Document 2: JP2013-147416 (A)
Patent Document 3: WO2012/131881
Patent Document 4: JP2011-119092 (A)

### SUMMARY OF INVENTION

### Problems to be Solved by the Invention

When assuming the application to a power source such as electric vehicles, it is required for a positive electrode active material for a non-aqueous electrolyte secondary battery to further improve its output characteristics without deteriorating its battery capacity and cycling characteristics. In order to achieve this, it is required for the positive electrode active material for a non-aqueous electrolyte secondary battery to further reduce the positive electrode resistance.

The present invention aims to provide a positive electrode active material for a non-aqueous electrolyte secondary battery comprising a structure that enables to further improve the output characteristics without deteriorating its battery capacity and cycling characteristics when constituting a secondary battery.

### Means for Solving the Problems

The first aspect of the present invention relates to a positive electrode active material for non-aqueous electrolyte battery. The positive electrode active material for non-aqueous electrolyte battery of the present invention comprises a lithium transition metal-containing composite oxide that is expressed by a general formula: Li₁₊ᵤNiₓMn_{y}Co₇MₜO₂, where −0.05≤u≤0.50, x+y+z+t=1, 0.3≤x≤0.7, 0.05≤y≤0.55, 0≤z≤0.55, 0≤t≤0.1, and M is one or more kind of added element selected from Mg, Ca, Al, Ti, V, Cr, Zr, Nb, Mo, Hf, Ta, and W, the lithium transition metal-containing composite oxide comprising secondary particles that are respectively constructed by an aggregation of a plurality of primary particles. The secondary particles comprise an outer shell section where the primary particles are aggregated, a center section constructed by an inner space that exists inside the outer shell section, and at least one through-hole that is formed in the outer shell section and communicates the center section and outside, and the ratio of the inner diameter of the through-hole with respect to the thickness of the outer shell section is 0.3 or more.

Preferably, the thickness ratio of the outer shell section with respect to the particle size of the secondary particles is within the range of 5% to 40%.

Preferably, the average inner diameter of the through-hole is within the range of 0.2 μm to 1.0 μm.

Preferably, the through-hole exists in the range of 1 to 5 per secondary particle.

Preferably, the average particle size of the secondary particles is within the range of 1 μm to 15 μm, and the value of [(d90−d10)/average particle size], which is an index that represents the spread of the particle size distribution, is 0.70 or less.

Preferably, the surface area per unit volume of the secondary particles is 2.0 m²/cm³ or more.

Preferably, the specific surface area of the secondary particles is within the range of 1.3 m²/g to 4.0 m²/g, and the tap density of the secondary particles is 1.1 g/cm³ or more.

The second aspect of the present invention relates to a non-aqueous electrolyte secondary battery comprising a positive electrode, negative electrode, separator, and non-aqueous electrolyte, and it is especially characterized in including a positive electrode active material for a non-aqueous electrolyte secondary battery of the present invention as a positive electrode material of the positive electrode.

### Effects of the Invention

By using the positive electrode active material for a non-aqueous electrolyte secondary battery of the present invention as a positive electrode material, it is possible to provide a non-aqueous electrolyte secondary battery having further improved output characteristics without deteriorating its battery capacity and cycling characteristics compared to the non-aqueous electrolyte secondary battery using a positive electrode active material which has a conventional hollow structure or perforated hollow structure as a positive electrode material, so the present invention has very large industrial significance.

### BRIEF DESCRIPTION OF DRAWINGS

FIG. 1 is an FE-SEM image illustrating the surface of the positive electrode active material for a non-aqueous electrolyte secondary battery that was obtained in Example 1.

FIG. 2 is an FE-SEM image illustrating the cross section of the positive electrode active material for a non-aqueous electrolyte secondary battery that was obtained in Example 1.

FIG. 3 is an FE-SEM image illustrating the surface of the positive electrode active material for a non-aqueous electrolyte secondary battery that was obtained in Comparative Example 1.

FIG. 4 is an FE-SEM image illustrating the cross section of the positive electrode active material for a non-aqueous electrolyte secondary battery that was obtained in Comparative Example 1.

FIG. 5 is a schematic cross sectional view of a 2032 type coin cell that was used in the battery evaluation.

FIG. 6 is a schematic view explaining the equivalent circuit that was used in the measurement example and analysis of the impedance evaluation.

### MODES FOR CARRYING OUT INVENTION

Regarding the positive electrode active material for a non-aqueous electrolyte secondary battery (hereinafter referred to as “positive electrode active material”) that was obtained based on the prior art such as WO2004/181891 and JP2011-110992 (A) and has a small particle size and a narrow particle size distribution, and comprises a hollow structure comprising an outer shell section and a hollow space section located inside the outer shell section or a perforated hollow structure, the inventors of the present invention performed an extensive study in order to further improve its output characteristics.

As a result, it was found that, by providing a through-hole that passes through to a hollow space section in the outer shell section of a positive electrode active material, it becomes possible for the electrolyte to sufficiently enter to the hollow space section that exists in the inside of the positive electrode active material, as well as for a conductive auxiliary agent to enter the hollow space section through the through-hole so as to make it possible to positively utilize the inner surface and outer surface of the secondary particles of the positive electrode active material as a reaction field and sufficiently reduce the positive electrode resistance of the positive electrode active material.

It was found that a positive electrode active material having such structure can be obtained by making the secondary particles of the transition metal-containing composite hydroxide (hereinafter referred to as “composite hydroxide”) to be a structure comprising a center section that is formed from fine primary particles, and an outer shell section having: a high density layer that is formed outside the center section and is formed from the plate-shaped primary particles; and a low density layer that is formed outside the high density layer and is formed from the fine primary particles; and an outer shell layer that is formed outside the low density layer and is formed from the plate-shaped primary particles. That is to say, a portion of the composite hydroxide that forms the outer shell section of the positive electrode active material by calcination is not constructed only by a high density layer formed from one layer of the plate-shaped primary particles, but is constructed by a three-layer structure in which a low density layer having a predetermined radial thickness and being formed from fine primary particles is sandwiched in the middle section in the radial direction between a high density layer and an outer shell layer formed from the plate-shaped primary particles, so that it is possible to form a through-hole that enables both of the electrolyte and the conductive auxiliary agent to enter in the outer shell section of the positive electrode active material due to the low density layer.

Further, in order to obtain a composite hydroxide that is formed from the secondary particles having such a structure, it is found that it is possible to alternately laminate the high density layer formed from plate-shaped primary particles and the low density layer formed from fine primary particles by continuing the supply of the raw material aqueous solution in the particle growth step while supplying atmospheric gas to the reaction system so as to switch the reaction atmosphere in a short period of time.

In addition, it is found that it is possible to form the positive electrode active material from secondary particles having a small particle size and a narrow particle size distribution, high spheroidicity, and excellent packing efficiency by making the composite hydroxide having said structure to be the precursor.

The present invention is achieved and completed based on the above technical knowledge.

1. Positive Electrode Active Material for Non-Aqueous Electrolyte Secondary Battery

(1-1) Particle Structure of Positive Electrode Active Material

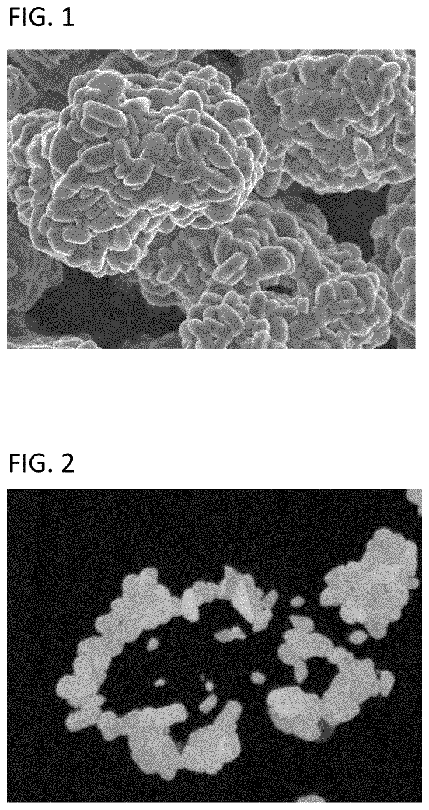

As illustrated in FIG. 1, the positive electrode active material of the present invention comprises secondary particles that are formed from aggregated primary particles. That is, the secondary particles is respectively constructed by an aggregate of a plurality of primary particles. Especially, in the positive electrode active material of the present invention, the whole of the secondary particles is not a solid structure that is formed from sintered aggregates of the primary particles. Instead, as illustrated in FIG. 1 and FIG. 2, it is characterized in that the secondary particles are respectively formed from an outer shell section where the primary particles are aggregated, a center section comprising an inner space that exists inside the outer shell section, and a through-hole that communicates the center section and the outside. That is, the secondary particles of the positive electrode active material of the present invention respectively has a hollow structure which comprises an outer shell section and a hollow space section located inside of the outer shell section that communicates with the outside via the through-hole.

In the positive electrode active material having such a particle structure, not only electrolyte but also conductive auxiliary agent can easily enter the center section (i.e. the internal space) of the secondary particles via the through-hole that is formed in the outer shell section. Therefore, extraction or insertion of lithium is sufficiently possible not only in the outside surface of the outer shell section of the secondary particles but also in the inside surface of the outer shell section of the secondary particles and the portion of the outer shell section that is exposed to the through-hole. Accordingly, the reduction of the positive electrode resistance is further achieved and the output characteristics can be improved by that amount.

In the present invention, such structure is achieved in a positive electrode active material that is constructed by a lithium transition metal-containing composite oxide, and that comprises secondary particles formed by an aggregate of a plurality of primary particles, the secondary particles having high spheroidicity, i.e. the secondary particles having a substantially nearly spherical shape (including spherical shape and oval shape) as a whole, and having a small particle size and a narrow particle size distribution.

In the secondary battery using the positive electrode active material having such a structure, in comparison to a secondary battery using a conventional positive electrode active material having a similar composition and having a small particle size and a narrow particle size distribution, it is possible to further improve the output characteristics while maintaining the battery capacity and the cycling characteristics at the same level, because not only the outside surface of the secondary particles (outer shell section) of the positive electrode active material but also the inside surface thereof can be efficiently utilized as a wider reaction field to react with the electrolyte.

(1-2) Average Particle Size

The average particle size of the secondary particles forming the positive electrode active material of the present invention is 1 μm to 15 μm, preferably 3 μm to 12 μm, more preferably 3 μm to 10 μm. When the average particle size of the positive electrode active material is within such range, it is possible to increase not only the battery capacity per unit volume of the secondary battery using this positive electrode active material, but also improve the safety and output characteristics. On the other hand, when the average particle size is less than 1 μm, the packing efficiency of the positive electrode active material decreases and it is impossible to increase the battery capacity per unit volume. When the average particle size becomes larger than 15 μm, it becomes difficult to improve the output characteristics as the contact interface decreases and the reaction surface of the positive electrode active material decreases

Here, the average particle size of the positive electrode active material means mean volume diameter (MV), and it is obtained by measuring with a laser beam diffraction scattering particle size analyzer.

(1-3) Outer Shell Section

The thickness ratio of the outer shell section with respect to the particle size of the secondary particles of the positive electrode active material of the present invention (hereinafter referred to as “the outer shell section ratio to particle size”) is preferably 5% to 40%, more preferably 10% to 35%, even more preferably 15% to 30%. Because of this, it becomes possible to improve the output characteristics in the secondary battery using this positive electrode active material without deteriorating the battery capacity and the cycling characteristics. On the other hand, when the outer shell section ratio to particle size is less than 5%, it becomes difficult to ensure the physical durability of the positive electrode active material and there is a probability that the cycling characteristics of the secondary battery lowers. When the outer shell section ratio to particle size becomes larger than 40%, the ratio of the center section (the ratio of the inner diameter of the outer shell section with respect to the particle size of the secondary particles) lowers and a problem may arise such as the reaction surface with the electrolyte cannot be sufficiently secured or the through-hole cannot be sufficiently formed so that there is a possibility that improving the output characteristics of the secondary battery may be difficult.

Here, the outer shell particle section ratio to particle size can be obtained by using an SEM image of the cross section of the positive electrode active material as follows. First, on an SEM image of the cross section of the positive electrode active material, the thickness of the outer shell section at arbitrary three or more positions per particle is measured, then the average thickness is obtained. Here, the thickness of the outer shell section is the shortest distance between two points on the outer edge of the outer shell section of the positive electrode active material and the surface thereof where the outer shell section faces the hollow space of the internal section. The average thickness of the outer shell section is obtained by performing the same measurement to more than ten positive electrode active materials and calculating the average value. Then, by dividing the average thickness of the outer shell section by the average particle size of the positive electrode active material, it is possible to obtain the thickness ratio of the outer shell section with respect to the particle size of the positive electrode active material. In the positive electrode active material of the present invention, there is a probability that part of the outer shell section breaks due to volumetric shrinkage in calcination and the hollow space in the internal section becomes exposed to the outside. In such a case, the outer shell section is determined as if the broken portion is connected, and the thickness of the outer shell section is measured in a measurable portion thereof.

In particular, although it depends on the average particle size of the secondary particles, the thickness of the outer shell section is preferably within the range of 0.1 μm to 6 μm, more preferably within the range of 0.2 μm to 5 μm, even more preferably within the range of 0.2 μm to 3 μm.

(1-4) Through-Hole

The positive electrode active material of the present invention is characterized in that a through hole is provided in the in the outer shell section that communicates the center section and the outside.

This through-hole is formed due to the shrinkage of the low density layer that existed between the layers of the outer shell section of the composite hydroxide when the composite hydroxide is fired and the outer shell section is integrated due to sintering shrinkage. At least one through-hole is formed in the outer shell section in a state where the through-hole passes through the outer shell section and communicates the center section of the hollow structure to the outside. From the point view of entering the electrolyte and the conductive auxiliary agent to the center section, it is sufficient if one through-hole having a certain size exists in one secondary particle. However, there may be a plurality of through-holes are provided in the outer shell section and, in this case, the number of the through-holes is preferably within the range of 1 to 5 per secondary particle, and more preferably within the range of 1 to 3.

The number of the through-hole is measureable by cross-section observation and surface observation of the secondary particles with a scanning microscope as the through-hole is sufficiently large with respect to the secondary particle diameter. In the surface observation, a through-hole can be confirmed as it is by changing the focus. In the surface observation, the orientation of the secondary particles is supposed to be random, and the through-hole does not necessarily exist in a direction of observable secondary particles. That is, when the secondary particles are rotated in two orthogonal axes that exist in a surface that is perpendicular to the observation direction, the location where a through-hole can be observed exists near the upper surface, in particular, within an angle of about 25% at most from each rotational axis. Therefore, as it is difficult to recognize a through-hole even if it exists in the back surface or the side surface, it is considered that a through-hole exists stochastically in approximately all the secondary particles if a through-hole is observed in more than 5% of the number of the observable secondary particles among the whole particles, and preferably in more than 6%. As for the number of the through-hole per secondary particle, as it is reasonable to obtain the number by excluding the secondary particles that observation of a through-hole is difficult, the number of the through-hole per secondary particle is obtained as an average by dividing the number of the through-holes by the number of the particles in which a through-hole is observed.

The size (inner diameter) of each through-hole is required to be a size that enables the electrolyte to sufficiently enter to the internal section of the positive electrode active material. The ratio of the inner diameter with respect to the thickness of the outer shell section (hereinafter referred to as “the through-hole inner diameter ratio to outer shell section”) is 0.3 or more, preferably 0.3 to 5, more preferably 0.4 to 3. When the through-hole inner diameter ratio to outer shell section becomes less than 0.3, the inner diameter of the through-hole with respect to the thickness of the outer shell section becomes too small and the through-hole becomes to have a relatively small inner diameter and long length, so that the electrolyte cannot sufficiently enter to the internal space (center section) that is formed in the internal section of the secondary particles. Moreover, the conductive auxiliary agent cannot enter into the center section or the amount of the conductive auxiliary agent that can enter into the center section decreases, so that the output characteristics and the battery capacity decrease when it is used for a battery. When the through-hole inner diameter ratio to outer shell section exceeds 5, the inner diameter of the through-hole becomes relatively too large, and the strength of the secondary particles lowers, leading to insufficiency in physical durability of the positive electrode active material.

In particular, although the inner diameter of the through-hole depends on the average particle size of the secondary particles and the thickness of the outer shell section, it is preferably within the range of 0.2 μm to 1.0 μm, more preferably within the range of 0.2 μm to 0.7 μm, even more preferably within the range of 0.3 μm to 0.6 μm. When the inner diameter of the through-hole is smaller than 0.2 μm, there may be a probability that the electrolyte does not sufficiently enter into the secondary particles and the conductive auxiliary agent cannot enter into the secondary particles. On the other hand, although the upper limit of the inner diameter of the through-hole depends on the average particle size of the secondary particles of the positive electrode active material, it is preferably about 5% to 20% of the average particle size of the secondary particles from the viewpoint of ensuring its physical durability.

The inner diameter of the through-hole (average inner diameter) can be obtained by measuring the shortest distance between two points on the border of the through-hole (the hollow space section that connects the external section and the center section of the secondary particles) and the outer-shell section in the secondary particles of which the through-hole can be observed and that are arbitrarily selected by using an SEM image of the cross section of the positive electrode active material to obtain the measured values, then performing the same measurement on 10 or more secondary particles, and calculating the average value based on the measured values and the number of the measured secondary particles. When a plurality of through-holes exist in one secondary particle, the average is calculated based on the measured values of the through-holes and the number of the through-holes of this secondary particle to obtain the measured value of this secondary particle, and then the average is calculated for the whole secondary particles using the measured value of this secondary particle together with the measured values of the other secondary particles. As the cross-section observation is an arbitrary cross section, the center of the through-hole is not necessarily on the cross section, and there may be a case where the measured value is smaller than the real diameter due to deviation from the center. However, the inner diameter of the through-hole in the above definition means the average of the inner diameters of the though-holes including the case where the values are smaller than the real diameters. Even with such an inner diameter of the through-hole, it is possible to obtain sufficient effect by specifying the range as described above.

(1-5) Particle Size Distribution

The average of [(d90−d10)/average particle size], which is an index indicating the spread of the particle size distribution of the positive electrode active material of the present invention, is 0.70 or less, preferably 0.60 or less, more preferably 0.55 or less. The positive electrode active material of the present invention is constructed by powder having an extremely narrow particle size distribution. Such a positive electrode active material has less content of fine particles and coarse particles, and the secondary battery using this positive electrode active material has excellent safety, cycling characteristics, and output characteristics.

On the other hand, when the value of [(d90−d10)/average particle size] exceeds 0.70, the existence ratio of fine particles and coarse particles in the positive electrode active material increases. For example, in a secondary battery using a positive electrode active material having a large content of fine particles, due to the local reaction of the fine particles, the secondary battery tends to generate heat, and not only safety deteriorates, but also cycling characteristics deteriorate due to selective deterioration of the fine particles. Further, in the secondary battery using a positive electrode active material having a large content of coarse particles, it is impossible to sufficiently secure the reaction surface between the electrolyte and the positive electrode active material and the output characteristics deteriorate.

When considering production of industrial scale, it is not realistic to produce powder composite hydroxide having excessively small value of [(d90−d10)/average particle size] as a precursor from the point of view of yield, productivity, or production cost. Therefore, it is preferable to set the lower limit of [(d90−d10)/average particle size] of the positive electrode active material to be about 0.25.

Here, d10 means the particle size when the number of particles in each particle size of powder sample is accumulated from smaller size and the cumulative volume becomes 10% of the total volume of all particles. Moreover, d90 means the particle size when the number of particles is accumulated in the same way and the cumulative volume becomes 90% of the total volume of all particles. As is the case with the average particle size of the positive electrode active material, d10 and d90 can be obtained from the volume integrated value measured with a laser beam diffraction scattering particle size analyzer.

(1-6) Specific Surface Area

In the positive electrode active material of the present invention, the specific surface area is preferably 1.3 m²/g to 4.0 m²/g, and more preferably 1.5 m²/g to 3.0 m²/g. A positive electrode active material having a specific surface area within such range has a large contact surface with the electrolyte and it is possible to largely improve the output characteristics of a secondary battery using this. On the other hand, when the specific surface area of a positive electrode active material is less than 1.3 m²/g, when a secondary battery is formed, it is impossible to secure a reaction surface with the electrolyte and it becomes difficult to sufficiently improve the output characteristics. When the specific surface area of a positive electrode active material is larger than 4.0 m²/g, the thermal stability may deteriorate as the reactivity with the electrolyte becomes too high.

Here, the specific surface area of a positive electrode active material can be measured by the BET method by nitrogen gas adsorption.

(1-7) Tap Density

In the positive electrode active material of the present invention, it is preferable to make the tap density which is an index of the packing efficiency to become 1.1 g/cm³ or more, more preferably 1.2 g/cm³ or more, and even more preferably 1.3 g/cm³ or more. When the tap density is less than 1.1 g/cm³, the packing efficiency is low and there is a possibility that the battery capacity of the whole secondary battery cannot be sufficiently improved. On the other hand, although the upper limit of the tap density is not particularly limited, but the upper limit in regular manufacturing conditions is about 3.0 g/cm³.

Here, the tap density represents the bulk density after tapping the sample powder which has been collected in a container for 100 times based on JIS Z2512:2012, and it can be measured using a shaking specific gravity measuring instrument.

(1-8) Surface Area per Unit Volume

In the positive electrode active material of the present invention, as is the case with the tap density, the surface area per unit volume which is a large index regarding the packing efficiency of the positive electrode active material is preferably 2.0 m²/cm³ or more, more preferably 2.1 m²/cm³ or more, even more preferably 2.3 m²/cm³ or more. Because of this, the contact area with the electrolyte can be increased while ensuring the packing efficiency as powder of the positive electrode active material, so the output characteristics and the battery capacity can be increased at the same time. Here, the surface area per unit volume can be obtained by the product of the specific surface area of the positive electrode active material and the tap density thereof.

(1-9) Composition

The positive electrode active material of the present invention has a composition that is expressed by a general formula: Li₁₊ᵤNiₓMn_{y}Co_{z}MₜO₂, where −0.05≤u≤0.50, x+y+z+t=1, 0.3≤x≤0.7, 0.05≤y≤0.55, 0≤z≤0.55, 0≤t≤0.1, and M is one or more kind of added element selected from Mg, Ca, Al, Ti, V, Cr, Zr, Nb, Mo, Hf, Ta, and W.

In this positive electrode active material, the value of u that indicates an excessive amount of lithium (Li) is preferably −0.05 or more and 0.50 or less, more preferably 0 or more and 0.50 or less, even more preferably 0 or more and 0.35 or less. By setting the value of u within the above ranges, it becomes possible to improve the output characteristics and the battery capacity of the secondary battery using this positive electrode active material as the positive electrode material. On the other hand, when the value of u is less than −0.05, as the positive electrode resistance of the secondary battery becomes large, it is impossible to improve the output characteristics. On the other hand, when the value of u is larger than 0.50, not only the initial discharge capacity lowers, but also the positive electrode resistance becomes large.

Nickel (Ni) is an element that contributes to make the voltage and the volume of the secondary battery higher and larger, and the value of x which indicates its content is 0.3 or more and 0.7 or less, preferably 0.3 or more and 0.6 or less. When the value of x is less than 0.3, it is impossible to improve the battery capacity of a secondary battery using this positive electrode active material. On the other hand, when the value of x exceeds 0.7, the content of other metal elements decrease and its effect can be obtained.

Manganese (Mn) is an element that contributes to improve thermal stability, and the value of y which indicates its content is 0.05 or more and 0.55 or less, preferably 0.05 or more and 0.45 or less. When the value of y is less than 0.05, it is impossible to improve the thermal stability of a secondary battery using this positive electrode active material. On the other hand, when the value of y exceeds 0.55, Mn elutes from the positive electrode active material in high temperature operation and the charge/discharge cycling characteristics deteriorate.

Cobalt (Co) is an element that contributes to improve charge/discharge cycling characteristics, and the value of z which indicates its content is 0 or more and 0.55 or less, preferably 0.10 or more and 0.55 or less. When the value of z exceeds 0.55, the initial discharge capacity of a secondary battery using this positive electrode active material largely lowers.

In the positive electrode active material of the present invention, in order to improve durability and output characteristics of a secondary battery, it may contain added element M in addition to the above transition metal elements. As for such added element M, it is possible to use one or more element which is selected from magnesium (Mg), calcium (Ca), aluminum (Al), titanium (Ti), vanadium (v), chromium (Cr), zirconium (Zr), niobium (Nb), molybdenum (Mo), hafnium (H), tantalum (Ta), and tungsten (W).

The value of t which indicates the content of M is preferably 0 or more and 0.1 or less, more preferably 0.001 or more and 0.05 or less. When the value of t is larger than 0.1, the battery capacity lowers as the metal element which contributes to the Redox reaction is reduced.

Such added element M may be uniformly dispersed in the internal section of the particle of the positive electrode active material, and it may also cover the particle surface of the positive electrode active material. Further, it may also be uniformly dispersed in the internal section of the particle and cover its surface. In any case, the content of added element M is required to be controlled to be within the above range.

2. Transition Metal-Containing Composite Hydroxide as Precursor of Positive Electrode Active Material

(2-1) Structure of Transition Metal-Containing Composite Hydroxide

The composite hydroxide of the present invention is a precursor of a positive electrode active material for a non-aqueous electrolyte secondary battery, and it comprises secondary particles that are formed by aggregates of a plurality of plate-shaped primary particles and a plurality of fine primary particles having a particle size that is smaller than that of the plate-shaped primary particles.

Especially, the secondary particles of the composite hydroxide of the present invention comprise a structure including:

a center section formed from the fine primary particles, and

an outer shell section constructed by a high density layer formed from the plate-shaped primary particles and formed outside the center section; a low density layer formed from the fine primary particles and formed outside the high density layer; and an outer shell layer formed from the plate-shaped primary particles and formed outside the low density layer. That is, the secondary particles comprise a structure comprising the center section and the outer shell section, and the outer shell section comprises a laminate structure formed from the high density layer, low density layer, and the outer shell layer.

In the composite hydroxide of the present invention, the outer shell section may possibly employ a structure wherein the high density layer and the low density layer are alternatively laminated by one layer each inside the outer shell layer, and also a structure wherein the high density layer and the low density layer are alternatively laminated by two layers each inside the outer shell layer.

First, the center section is a structure having a lot of gaps where fine primary particles are continuous, so when compared to the high density layer and the outer shell layer formed from plate-shaped primary particles that are larger and thicker, in the calcination process for making the composite hydroxide as the positive electrode active material, the calcination proceeds from the low temperature area and shrinkage proceeds from the center of a particle to the high density layer side where the calcination proceeds slowly, then a space occurs in the center section. Because of this, the positive electrode active material that is obtained after calcination becomes a hollow structure comprising an outer shell section and a hollow space section located inside of the outer shell section.

Especially in the secondary particles forming the composite hydroxide of the present invention, it does not comprise an outer shell section comprising only one layer of high density layer around the center section as in the conventional structure, but instead it has a laminate structure where a low density layer having a predetermined thickness in the radial direction between the high density layer and the outer shell layer.

Due to such a structure, in calcination, a hollow space section is formed due to a portion in the structure which has a lot of gaps where fine primary particles of the low density layer are continuous shrinks to the high density layer and the outer shell layer side, however, the hollow space section does not comprise enough thickness in the radial direction so as to be able to retain its shape. As the calcination proceeds, the high density layer and the outer shell layer form one layer of outer shell section by substantially being integrated while absorbing the low density portion. At this time, the volume of the low density portion which was absorbed during the formation is not compensated, and therefore it is considered that, due to shrinkage of the high density layer and the outer shell layer shrink during calcination, a through-hole penetrating the integrated outer shell section outward and inward and having a sufficient size is formed.

In the secondary particles of the positive electrode active material that was obtained with the composite hydroxide of the present invention as a precursor, the electrical conduction of the entire outer shell section is secured and the through-hole formed in the outer shell section comprises a predetermined length and inner diameter, so that not only electrolyte but also conductive auxiliary agent can sufficiently enter the hollow space section that exists inside the outer shell section through the through-holes. Therefore, it becomes possible to positively utilize the internal and external surfaces of the secondary particles (outer shell section) as the reaction field with the electrolyte, so as to largely decrease the internal resistance of the positive electrode active material.

(2-2) Average Particle Size of Transition Metal-Containing Composite Hydroxide

The average particle size of the secondary particles of the composite hydroxide of the present invention is adjusted to 1 μm to 15 μm, preferably 3 μm to 12 μm, and more preferably 3 μm to 10 μm. The average particle size of the positive electrode active material is correlated with the average particle size of the composite hydroxide which is its precursor. Therefore, by setting the average particle size of the composite hydroxide in such ranges, it becomes possible to set the average particle size of the positive electrode active material within the predetermined range.

In the present invention, the average particle size of the composite hydroxide means the volume-based average particle diameter (MV), and it can be obtained by measurement with a laser beam diffraction scattering particle size analyzer.

(2-3) Particle Size Distribution of Transition Metal-Containing Composite Hydroxide

The value of [(d90−d10)/average particle size] which is an index indicating the spread of the particle size distribution of the secondary particles of the composite hydroxide of the present invention is adjusted to 0.65 or less, preferably 0.55 or less, and more preferably 0.50 or less.

The particle size distribution of the positive electrode active material is strongly affected by the composite hydroxide which is its precursor. Therefore, when the positive electrode active material is manufactured with a composite hydroxide containing a lot of fine particles and coarse particles as a precursor, the positive electrode active material also contains a lot of fine particles and coarse particles so that it becomes impossible to sufficiently improve the safety cycling characteristics and output characteristics of the secondary battery using this. Therefore, in the particle size distribution of the composite hydroxide which is its precursor, by adjusting the value of [(d90−d10)/average particle size] to becomes 0.65 or less, it becomes possible to narrow the particle size distribution of the positive electrode active material as well as to avoid problems related to above-said battery characteristics, especially to the problems related to the safety and cycling characteristics due to selective deterioration of the fine particles. However, when considering production in industrial scale, manufacturing composite hydroxide in a powder state where the value of [(d90−d10)/average particle size] is excessively small, it is not realistic from the points of view of yield, productivity, or production cost. Therefore, the lower limit of the value of [(d90−d10)/average particle size] is preferably about 0.25.

Here, d10 means the particle size where the number of particles in each particle size is accumulated from the side where the particle size is smaller and the cumulative volume becomes 10% of the total volume of all particles, and d90 means the particle size where the cumulative volume becomes 90% of the total volume of all particles when the number of particles is accumulated in a similar method. Similar to the average particle size of the composite hydroxide, d10 and d90 can be obtained by the volumetric integrated value that was measured with a laser beam diffraction scattering particle size analyzer.

(2-4) Primary Particles

In the composite hydroxide of the of the present invention, the average particle size of the fine primary particles that are the constituent elements of the center section and the low density layer is preferably within the range of 0.01 μm to 0.3 μm, more preferably within the range of 0.1 μm to 0.3 μm. When the average particle size of the fine primary particles is less than 0.01 μm, there may be a case where the thickness of the low density layer cannot be sufficiently obtained. On the other hand, when the average particle size of the fine primary particles becomes more than 0.3 μm, the volume shrinkage due to heating does not sufficiently proceed in calcination in the low temperature area in the calcination process for manufacturing the positive electrode active material so that the difference in the amount of the volume shrinkage between the center section and the low density layer, high density layer and the outer shell layer becomes small and the center section comprising sufficient size of gap in the center of the secondary particles of the positive electrode active material is not formed, or there may be a case where a sufficient size of through-hole that communicates the center section with the outside of the secondary particles is not formed in the outer shell section of the secondary particles of the positive electrode active material.

The shape of such fine primary particles is preferably needle-shaped. The needle-shaped primary particles comprise a shape having a one-dimensional direction, so they form a structure having a lot of gaps when the particles aggregate, that is, a structure having low density. Because of this, the difference in density between the center section and the low density layer and the high density layer and the outer shell layer can be sufficiently large.

On the other hand, the plate-shaped primary particles forming the high density layer and the outer shell layer of the secondary particles of the composite hydroxide have an average particle size that fall within the range of preferably 0.3 μm to 3 μm, more preferably within the range of 0.4 μm to 1.5 μm, even more preferably within the range of 0.4 μm to 1.0 μm. When the average particle size of the plate-shaped primary particles is less than 0.3 μm, in the calcination process for manufacturing the positive electrode active material, the volume shrinkage of the plate-shaped primary particles occurs also in the low temperature area, the amount of the volume shrinkage difference between the high density layer and the outer shell layer and the center section and the low density layer becomes small, sufficient hollow structure cannot be obtained in the positive electrode active material or there may be a case where sufficient amount of absorption of the low density layer cannot be obtained in the positive electrode active material for forming the through-holes. On the other hand, when the average particle size of the plate-shaped primary particles is larger than 3 μm, in the calcination process when manufacturing the positive electrode active material, in order to improve the crystallinity of the positive electrode active material, calcination in even higher temperature is required and calcination between the secondary particles of the composite hydroxide proceeds and it becomes difficult to set the average particle size of the positive electrode active material and the particle size distribution in the predetermined range.

When the fine primary particles are formed from the needle-shaped primary particles, the difference of the average particle size between the fine primary particles and the plate-shaped primary particles is preferably 0.1 μm or more, more preferably 0.2 μm or more. When the fine primary particles have a structure that is closer to that of e.g. plate-shaped primary particles, the difference of the average particle size between the fine primary particles and the plate-shaped primary particles is preferably 0.2 μm or more, more preferably 0.3 μm or more.

The average particle size between the fine primary particles and the plate-shaped primary particles can be determined by embedding the composite hydroxide in a resin or the like and enabling the cross-section observation to be performed using a cross-section polisher processing or the like and then observing its cross section with a field emission scanning electron microscope (FE-SEM) as follows. First, the maximum outer diameter (long axis diameter) of more than 10 fine primary particles or plate-shaped primary particles that exist in the cross section of the secondary particles of the composite hydroxide is measured to obtain its average value. This value is made to be the particle size of the fine primary particles or the plate-shaped primary particles in these secondary particles. Next, regarding more than 10 secondary particles, the particle size of the fine primary particles or the plate-shaped primary particles is similarly obtained. Lastly, by obtaining the average of the particle size of the fine primary particles or the plate-shaped primary particles that was obtained regarding these secondary particles, the average particle size of fine primary particles or plate-shaped primary particles of the whole composite hydroxide including these secondary particles is determined.

(2-5) Composition of Transition Metal-Containing Composite Hydroxide

The composite hydroxide of the present invention has a composition that is expressed by a general formula: Ni₁Mn_{y}Co_{z}Mₜ (OH)₂₊ₐ, where x+y+z+t=1, 0.3≤x≤0.7, 0.05≤y≤0.55, 0≤z≤0.55, 0≤t≤0.1, 0≤a≤0.5, and M is one or more kind of added element that is selected from Mg, Ca, Al, Ti, V, Cr, Zr, Nb, Mo, Hf, Ta, W. By employing a composite hydroxide having such composition as a precursor, a positive electrode active material that has a composition that is expressed by a general formula: Li₁₊ᵤNiₓMn_{y}Co_{z}MₜO₂, where −0.05≤u≤0.50, x+y+z+t=1, 0.3≤x≤0.7, 0.05≤y≤0.55, 0≤z≤0.55, 0≤t≤0.1, and M is one or more kind of added element selected from Mg, Ca, Al, Ti, V, Cr, Zr, Nb, Mo, Hf, Ta, and W, and enables even higher battery characteristics can be easily obtained.

In a composite hydroxide having this kind of composition, the added element M can be crystalized together with transition metals (nickel, cobalt, and manganese) by a crystallization reaction and can be uniformly dispersed in the secondary particles forming the composite hydroxide, but it may also be possible to cover the outermost surface of the secondary particles of the composite hydroxide with a compound that mainly contains the added element M after the crystallization reaction. Further, in the mixing process of manufacturing the positive electrode active material, it is also possible to mix a compound containing the added element M together with a lithium compound with respect to the composite hydroxide. Furthermore, these methods may be used together. In either case, it is required to adjust the content of the added element M in the composite hydroxide.

3. Manufacturing Transition Metal Composite Hydroxide as Precursor

(3-1) Aqueous Feed Solution

In the manufacturing method of the composite hydroxide of the present invention, by supplying raw material aqueous solution containing at least transition metal, preferably nickel, nickel and manganese, or nickel and manganese and cobalt into a reaction tank to prepare a reaction aqueous solution, and while adjusting the pH value of this reaction aqueous solution to be within a predetermined range with a pH adjusting agent, a composite hydroxide is obtained by a crystallization reaction.

a) Raw Material Aqueous Solution

In the present invention, the ratio of the metal elements that are contained in the raw material aqueous solution becomes the composition of the composite hydroxide that can be actually obtained. Therefore, the raw material aqueous solution is required to suitably adjust each metal component based on the composition of the aimed composite hydroxide. For example, in order to obtain the composite hydroxide having a composition being expressed by the general formula indicated above, the ratio of the metal element in the raw material aqueous solution is required to be adjusted to Ni:Mn:Co:M=x:y:z:t, where, x+y+z+t=1, 0.3≤x≤0.7, 0.05≤y≤0.55, 0≤z≤0.55, 0≤t≤0.1. However, when the added element M is introduced in a different process as described above, the raw material aqueous solution is made not to include the added element M. Further, in the nucleation step and the particle growth step, it is also possible to add or not to add the added element M, or to change the content ratio of the transition metal and the added element M.

The compound of the transition metal for preparing the raw material aqueous solution is not specifically limited, but in view of ease of handling, it is preferable to use such as water-soluble nitrate, sulfates, and hydrochloride salt, and in view of raw material cost and preventing contamination of halogen component, it is especially preferable to use sulfates.

When to include the added element M, where M is one or more kind of added element selected from Mg, Ca, Al, Ti, V, Cr, Zr, Nb, Mo, Hf, Ta, and W, in the composite hydroxide, as a compound to supply the added element M, water-soluble compound is similarly preferable. For example, magnesium sulfate, calcium sulfate, aluminum sulfate, titanium sulfate, peroxotitanate ammonium, potassium titanium oxalate, vanadium sulfate, ammonium vanadate, chromium sulfate, potassium chromate, zirconium sulfate, niobium oxalate, ammonium molybdate, sulfuric acid hafnium, sodium tantalite, sodium tungstate, and ammonium tungstate and the like may be suitably used.

The concentration of the raw material aqueous solution is determined based on the total amount of substance of the metal compound, but it is preferably 1 mol/L to 2.6 mol/L, more preferably 1.5 mol/L to 2.2 mol/L. When the concentration of the raw material aqueous solution is less than 1 mol/L, the crystallization product amount per reaction tank volume becomes small so that the productivity deteriorates. On the other hand, when the concentration of a mixed aqueous solution exceeds 2.6 mol/L, it exceeds saturated concentration at the room temperature, so that crystals of each metal compound re-precipitate and there may be a probability that pipes or the like may be clogged.

The metal compounds mentioned above may not be necessarily supplied in the reaction tank as the raw material aqueous solution. For example, when performing crystallization reaction by using a metal compound that produces a compound that is not the aimed compound when mixed and reacted, metal compound aqueous solutions are individually prepared to make the concentration of all the metal compound aqueous solutions will be within the above-mentioned range, and it may be supplied to the reaction tank at a predetermined ratio as an aqueous solution of each metal compound.

Further, the supplied amount of the raw material aqueous solution is set so that the concentration of the product in the reaction aqueous solution at the termination point of the particle growth step is preferably 30 g/L to 200 g/L, more preferably 80 g/L to 150 g/L. When the concentration of the product is less than 30 g/L, there may be a case where the aggregation of the primary particles is insufficient. On the other hand, when it exceeds 200 g/L, stirring of the reaction aqueous solution in the reaction tank is not sufficiently performed so that the aggregation condition becomes uneven, and there may be a probability that the particle growth may be biased.

b) Alkaline Aqueous Solution

The alkaline aqueous solution for adjusting the pH value of the reaction aqueous solution is not specifically limited, and general alkali metal hydroxide aqueous solution such as sodium hydroxide and potassium hydroxide can be used. Although it is also possible to add alkali metal hydroxide directly to the reaction aqueous solution in the solid state, in view of ease of controlling the pH value, it is preferable to add it as an aqueous solution. In this case, the concentration of the alkali metal hydroxide aqueous solution is preferably 20% by mass to 50% by mass, more preferably 20% by mass to 30% by mass. By setting the concentration of the alkali metal aqueous solution to be within such ranges, while the amount of solvent to be supplied to the reaction system, that is the amount of water is suppressed, it is possible to prevent local rise of the pH value so that it becomes possible to efficiently obtain a composite hydroxide having a narrow particle size distribution.

The supply method of the alkaline aqueous solution is not specifically limited as long as the pH value of the reaction aqueous solution is not locally high as well as it is maintained within the predetermined range. For example, while sufficiently stirring the reaction aqueous solution, it is possible to supply the alkaline aqueous solution with a pump such as a metering pump that is able to control the flow rate.

(3-2) Crystallization Reaction

In the manufacturing method of the composite hydroxide of the present invention, the crystallization reaction is clearly divided into two processes: a nucleation step where nucleation is mainly performed, and a particle growth step where particle growth is mainly performed. The conditions of the crystallization reaction in each process is adjusted, and it is characterized in that, in the particle growth step, while maintaining supply of the raw material aqueous solution in the particle growth step, the primary particle diameter is controlled by changing the degree of supersaturation of the metal element contained in the reaction aqueous solution.

[Nucleation Step]

In the nucleation step, first, a compound of a transition metal that becomes the raw material of the composite hydroxide is dissolved in water to prepare a raw material aqueous solution. Further, an alkaline aqueous solution is supplied to the reaction tank to prepare a pre-reaction aqueous solution wherein the pH value to be measured at a standard solution temperature of 25° C. is 12.0 to 14.0. The pH value of the pre-reaction aqueous solution can be measured with a pH meter.

Next, the raw material aqueous solution is supplied while stirring this pre-reaction aqueous solution. By doing this, in the reaction tank, a reaction aqueous solution in the nucleation step, that is, an aqueous solution for nucleation is formed. As the pH value of this reaction aqueous solution is within the above ranges, the nucleus barely grows and nucleation occurs preferentially. Here, in the nucleation step, the pH value of the reaction aqueous solution changes following the nucleation so that an alkaline aqueous solution is supplied at a suitable timing and the pH value of the reaction aqueous solution at a standard solution temperature of 25° C. is controlled to be maintained within the range of 12. to 14.0.

Further, during the nucleation step, fine primary particles are formed by increasing the degree of supersaturation in the reaction aqueous solution in the reaction tank. The degree of supersaturation can be controlled by the pH value of the reaction aqueous solution.

In the nucleation step, by supplying the raw material aqueous solution and the alkaline aqueous solution to the reaction aqueous solution, continuous nucleation reaction is maintained, and the nucleation step is terminated at the point where a predetermined amount of nuclei is formed in the reaction aqueous solution.

When doing this, the amount of the produced nuclei can be determined by the amount of the metal compound that is contained in the raw material aqueous solution that is supplied to the reaction aqueous solution. The amount of the produced nuclei in the nucleation step is not specifically limited, but in order to obtain a composite hydroxide having a narrow particle size distribution, it is preferably to be 0.1 atom % to 2 atom %, more preferably to be 0.1 atom % to 1.5 atom % with respect to the whole amount of the metal element in the metal compound that is contained in the raw material aqueous solution that is supplied through the nucleation step and the particle growth step. The reaction time in the nucleation step is generally about 0.2 minutes to 5 minutes.

[Particle Growth Step]

After the termination of the nucleation step, the pH value at a standard solution temperature of 25° C. of the aqueous solution for nucleation in the reaction tank is adjusted to be 10.5 to 12.0 to form a reaction aqueous solution in the particle growth step, that is, an aqueous solution for particle growth. The pH value is adjustable by stopping the supply of the alkaline aqueous solution, however, in order to obtain a composite hydroxide having a narrow particle size distribution, it is preferable to adjust the pH value after stopping all the supply of the aqueous solution. Specifically, it is preferable to adjust the pH value by supplying inorganic acid having a group that is the same as that of the metal compound used for preparing the raw material aqueous solution after stopping all the supply of the aqueous solution.

Then, while stirring this reaction aqueous solution, the supply of the raw material aqueous solution is resumed. By doing this, the pH value of the reaction aqueous solution is within the above ranges, new nuclei are barely formed and the particle growth proceeds, and the crystallization reaction is maintained until the secondary particles of the transition metal composite hydroxide reach the predetermined particle size. In the particle growth step as well, it is required to supply the alkaline aqueous solution and the complexing agent aqueous solution at a suitable timing to maintain the pH value to be within the above ranges and maintain the concentration of the complexing agent to be within a certain range. The overall reaction time in the particle growth step is generally about 1 to 6 hours.

Especially, in the manufacturing method of the composite hydroxide of the present invention, as in the nucleation step, while maintaining high degree of supersaturation so that fine primary particles are formed, the center section of the secondary particles of the composite hydroxide is formed in the initial step of the particle growth step. Next, after termination of the initial step of the particle growth step, while maintaining supply of the raw material aqueous solution, plate-shaped primary particles are formed by lowering the degree of supersaturation of the reaction aqueous solution. By doing this, first layer of the high density layer is formed around the center section of the secondary particles of the composite hydroxide. In the particle growth step, a complexing agent such as an aqueous ammonia solution may be added in order to ease the control of the degree of supersaturation.

Then, while continuing to supply the raw material aqueous solution, the condition is switched so that the degree of supersaturation becomes high again in the reaction aqueous solution. By switching, the first layer of the low density layer is formed to cover the first layer of the high density layer. When doing this, in order to prevent excessive mixing of the plate-shaped primary particles when switching the condition, the supply of the raw material aqueous solution may be suspended when it takes time for switching and the like.

Further, while continuing to supply the raw material aqueous solution, the condition is switched again so that the degree of supersaturation of the reaction aqueous solution becomes low. By switching, the second layer of the high density layer (outer shell layer) is formed to cover the first layer of the low density layer. Due to the controlling of switching such crystallization condition, a structure having a low density layer between the high density layers, which is an outer shell section having a high density layer, a low density layer, and an outer shell layer, is formed outside the center section of the secondary particles of the composite hydroxide.

In the present invention, it is characterized in that such switching of the crystallization condition is performed for at least three times during the crystallization reaction. After that, it is possible to repeat switching the crystallization condition in a similar way. By controlling the switching of such crystallization condition, a structure in which a structure having a low density layer between the high density layers is double-laminated, which is an outer shell section having a laminate structure of the first high density layer, the first low density layer, the second high density layer, the second low density layer, and the outer shell layer, is formed outside the center section of the secondary particles of the composite hydroxide, that is.

In such manufacturing method of the composite hydroxide, the metal ion in the reaction aqueous solution precipitate as solid nuclei or primary particles in the nucleation step and the particle growth step. Therefore, the ratio of the liquid component with respect to the metal ion content in the reaction aqueous solution increases. As the reaction proceeds, the metal ion concentration of the reaction aqueous solution lowers, so that especially in the particle growth step, there may be a probability that the growth of the composite hydroxide stagnates. Therefore, in order to suppress increase in the ratio of the liquid component, that is, in order to suppress reduction of the apparent metal ion concentration, it is preferable to discharge part of the liquid component of the reaction aqueous solution outside the reaction tank after termination of the nucleation step and during the particle growth step. Specifically it is preferable to suspend supplying the raw material aqueous solution, the alkaline aqueous solution, and the aqueous solution including complexing agent into the reaction tank as well as to suspend stirring the reaction aqueous solution, and settle the solid component (i.e. composite hydroxide) in the reaction aqueous solution, and discharge only supernatant liquid of the reaction aqueous solution outside the reaction tank. By doing such an operation, it is possible to maintain the metal ion concentration in the reaction aqueous solution, so that it is possible not only to prevent stagnation of the particle growth and control the particle size distribution of the to-be-obtained composite hydroxide to be within a suitable range, but also improve the density as powder.

[Controlling Particle Size of Composite Hydroxide]

The particle size of the secondary particles of the composite hydroxide can be controlled by controlling the time for performing the nucleation step and the particle growth step, and the pH value of the reaction aqueous solution and the supply of the raw material aqueous solution in each step. For example, when the nucleation step is performed at a high pH value, or the nucleation step is performed for a long time, or the metal concentration of the raw material aqueous solution is increased, the amount of nucleation in the nucleation step increases and a composite hydroxide having a relatively small particle size is obtained after the particle growth step. On the centrally, when the amount of nucleation in the nucleation step is suppressed, or the time for performing the particle growth step is sufficiently long, it is possible to obtain a composite hydroxide having a large particle size.

[Another Embodiment of Crystallization Reaction]

In the manufacturing method of the composite hydroxide of the present invention, other than the reaction aqueous solution, an aqueous solution for adjusting component that is adjusted at a pH value suitable for the particle growth step is prepared. A reaction aqueous solution after nucleation step, preferably a solution in which part of the liquid component is removed from the reaction aqueous solution after the nucleation step, is added to or mixed in this aqueous solution for adjusting component, and this mixed solution is used as a reaction aqueous solution to perform the particle growth step.

In this case, as it is possible to perform separation of the nucleation step and the particle growth step more reliably, it is possible to control the reaction aqueous solution in each step to be in an optimal state. Especially, as the pH value of the reaction aqueous solution can be controlled to be in an optimal range from the initiation of the particle growth step, it is possible to make the particle size distribution of the to-be-obtained composite hydroxide even narrower.

(3-3) pH Value

In the manufacturing method of the composite hydroxide of the present invention, the pH value at a standard solution temperature of 25° C. is required to be controlled to be within the range of 12.0 to 14.0 when performing the nucleation step, and 10.5 to 12.0 and lower than that of the nucleation step when performing the particle growth step. Further, by changing the pH value of each step within the above ranges, it is possible to adjust the degree of supersaturation in the reaction aqueous solution. That is, increasing the pH value affects to increase the degree of supersaturation, and decreasing the pH value affects to lower the degree of supersaturation. In either step, the variation amount of the pH value in the crystallization reaction is preferably controlled to be within the range of 0.2 with respect to the set value. When the variation amount of the pH value is large, the nucleation amount in the nucleation step and the degree of the particle growth in the particle growth step do not become constant, it may become difficult to obtain a composite hydroxide having a narrow particle size distribution. Therefore, a complexing agent such as aqueous ammonia solution may be added especially in the particle growth step.

a) pH value of Nucleation Step

In the nucleation step, the pH value at a standard solution temperature of 25° C. of the reaction aqueous solution is required to be controlled to be within a range of 12.0 to 14.0, preferably 12.3 to 13.5, more preferably to be more than 12.5 and 13.3 or less. By doing this, the growth of the nuclei in the reaction aqueous solution is suppressed, and it becomes possible to prioritize the nucleation only so that it becomes possible to make the nuclei produced in this step to have a uniformed size and a narrow particle size distribution. Further, by making the pH value higher than 12.5, it becomes possible to reliably form a structure having a lot of gaps where fine primary particles are continuous in the center section of the secondary particles of the composite hydroxide. When the pH value is less than 12.0, as the growth of nuclei proceeds together with nucleation, the particle size of the obtained composite hydroxide becomes uneven and the particle size distribution becomes wide. Further, when the pH value is made to be higher than 14.0, produced nuclei becomes too fine so that a problem of gelation of the reaction aqueous solution occurs.

b) pH value of Particle Growth Step

In the particle growth step, the pH value at a standard solution temperature of 25° C. of the reaction aqueous solution is required to be controlled to be 10.5 to 12.0, preferably 11.0 to 12.0, more preferably 11.5 to 12.0. By doing this, production of new nuclei is suppressed and it becomes possible to prioritize the particle growth, and it becomes possible to make the obtained composite hydroxide to be homogeneous and have a narrow particle size distribution. On the other hand, when the pH value is less than 10.5, the ammonium ion concentration increases and the solubility of metal ion becomes high, so that not only the speed of the crystallization reaction becomes slow, but also the metal ion content that remain in the reaction aqueous solution increases, and the productivity deteriorates. Further, when the pH value becomes higher than 12.0, the nucleation amount in the particle growth step increases and the particle size of the obtained composite hydroxide becomes uneven, and the particle size distribution becomes wide.

When the pH value at a standard solution temperature of 25° C. of the reaction aqueous solution is 12.0, that is the boundary condition of nucleation and nuclear growth, depending on the existence of nuclei in the reaction aqueous solution, it is possible to make the condition either of the nucleation step or the particle growth step. For example, if the pH value is made to be 12.0 after making the pH value in the nucleation step higher than 12.0 and performing a lot amount of nucleation, as a lot of nuclei that becomes reactant exist in the reaction aqueous solution, particle growth occurs preferentially and it is possible to obtain a composite hydroxide having a narrow particle size distribution. On the other hand, if the pH value of the nucleation step is made to be 12.0, as no nuclei to grow exists in the reaction aqueous solution, nucleation occurs preferentially and by making the pH value in the particle growth step less than 12.0, growth of the produced nuclei proceeds.

In either case, the pH value in the particle growth step may be controlled to a value that is lower than that of the nucleation step, and in order to clearly separate the nucleation and the particle growth, the pH value of the particle growth step is preferably made to be lower for 0.5 or more than the pH value of the nucleation step, more preferably 1.0 or more lower.

(3-4) Reaction Temperature

The temperature of the reaction aqueous solution, that is, the reaction temperature of the crystallization reaction is required to be controlled preferably to be within the range of 20° C. or more, more preferably 20° C. to 80° C. throughout the nucleation step and the particle growth step. When the reaction temperature is less than 20° C., due to the solubility of the reaction aqueous solution becomes low, nucleation tends to occur and it becomes difficult to control the average particle size and particle size distribution of the obtained composite hydroxide. The upper limit of the reaction temperature is not specifically limited, but when the reaction temperature exceeds 80° C., the volatilization of moisture of the reaction aqueous solution is facilitated so that there may be a case where it becomes complicated to control the degree of supersaturation of the reaction aqueous solution to be within a certain range.

(3-5) Coating Process

In the manufacturing method of the composite hydroxide of the present invention, by adding a compound including the added element M into a raw material aqueous solution, especially in the raw material aqueous solution that is used in the particle growth step, it is possible to obtain a composite hydroxide having the added element M which are uniformly dispersed in the internal section of the particles. However, in order to obtain an effect by adding the added element M with a lesser addition, it is preferable to perform a coating process where the surface of the secondary particles of the transition metal composite hydroxide with a compound including the added element M after the particle growth step.

The covering method is not specifically limited as long as it is possible to uniformly cover the composite hydroxide with a compound including the added element. For example, after forming a slurry with a composite hydroxide and controlling its pH value to be within a predetermined range, by adding an aqueous solution for coating to which a compound including the added element M is dissolved, and by precipitating the compound including the added element M on the surface of the secondary particles of the composite hydroxide, it becomes possible to obtain a composite hydroxide that is uniformly covered with the compound including the added element M. In this case, an alkoxide aqueous solution of the added element M may be added to the slurried composite hydroxide instead of the aqueous solution for coating. Further, instead of forming a slurry with the composite hydroxide, it is also possible to cover the composite hydroxide by spraying the aqueous solution or the slurry to which the compound including the added element M is dissolved and them drying it. Furthermore, it is also possible to cover the composite hydroxide with a method of spraying and drying a slurry in which the composite hydroxide and the compound including the added element M are suspended, or mixing the composite hydroxide and the compound including the added element M by a solid-phase method and the like.

When to cover the surface of the composite hydroxide with the added element M, it is required to suitably adjust the composition of the raw material aqueous solution and the aqueous solution for coating so that the composition of the composite hydroxide after covering match with the composition of the aimed composite hydroxide. Further, the coating process may be performed on the heat-treated particles after heat-treating the composite hydroxide in the heat-treating step in manufacturing the positive electrode active material.

(3-6) Manufacturing Apparatus

The crystallization apparatus for manufacturing the composite hydroxide of the present invention, that is, the reaction tank is not specifically limited as long as it is possible to switch the reaction atmosphere, however, it is preferable to use a reaction tank that has a means such as an aeration tube for directly supplying an atmospheric gas into the reaction tank. Further, when embodying the present invention, it is especially preferable to use a batch type crystallization apparatus that does not collect the precipitated product until the crystallization reaction is terminated. In such a crystallization apparatus, as it is different from the continuous crystallization apparatus that collects the product by an overflow method, the particles in the growth are not collected at the same time with the overflow solution, so that the particle structure comprising the low density layer and the high density layer is controlled and it is possible to accurately obtain a composite hydroxide having a narrow particle size distribution. Further, the manufacturing method of the composite hydroxide of the present invention requires to suitably control the reaction atmosphere of the crystallization reaction, so that it is especially preferable to use a closed type crystallization apparatus.

4. Manufacturing Method of Positive Electrode Active Material for Non-Aqueous Electrolyte Secondary Battery

The manufacturing method of the positive electrode active material of the present invention is not specifically limited as long as it uses the composite hydroxide that was obtained in the manufacturing method described above as a precursor and is able to synthesize a positive electrode active material comprising a predetermined structure, average particle size, and particle size distribution. However, when manufacturing in an industrial scale is performed, it is preferable that a positive electrode active material is synthesized by a manufacturing method comprising a mixing process in which the above composite hydroxide is mixed with a lithium compound to obtain a lithium mixture and a calcination step where the obtained lithium mixture is calcined in an oxidizing atmosphere at a temperature range of 650° C. to 1000° C. Processes such as heat treatment process or pre-calcining step may be added to the above steps if needed. With such a manufacturing method, the above positive electrode active material, especially the positive electrode active material that is expressed by the above general formula can be easily obtained.

(4-1) Heat-Treating Process

In the manufacturing method of the positive electrode active material of the present invention, a heat-treating process where the composite hydroxide is heat-treated is optionally provided before the mixing process and then the heat-treated composite hydroxide as heat-treated particles is mixed with a lithium compound. Here, the heat-treated particles include not only the composite hydroxide where the excess moisture has been removed in the heat-treating process but also a transition metal-containing composite oxide which has been converted into an oxide, or the mixture of these.

The heat-treating process is a process where the composite hydroxide is heat-treated by heating it to the temperature range of 105° C. to 750° C. to remove the excess moisture included in the composite hydroxide. By doing this, the moisture remaining until after the calcination step can be reduced to a certain amount, and it becomes possible to suppress variation in the composition of the obtained positive electrode active material. When the heating temperature is less than 105° C., the excess moisture in the composite hydroxide cannot be removed and there may be a case where the variation cannot be sufficiently suppressed. On the other hand, when the heating temperature is higher than 750° C., not only further effect cannot be expected but also the production cost will increase.

Further, in the heat-treating process, the moisture may be removed to the extent that variations do not occur in the number of atom of each metal component in the positive electrode active material and the ratio of the number of atoms of Li, so that not all of the composite hydroxide is required to be converted to composite oxide. However, in order to make the variation in the ratio of the number of atoms of each metal component and the ratio of the number of atoms of Li lesser, it is preferable to heat the composite hydroxide to 400° C. or more and all of the composite hydroxide is converted to composite oxide. By calculating the metal component ratio that is included in the composite hydroxide by the heat treatment condition in advance by chemical analysis and determine the mixing ratio with the lithium compound, it is possible to further suppress the variation.

The atmosphere in which the heat treatment is performed is not specifically limited, and it may be a non-reducing atmosphere, but it is preferable that it is performed in a stream of air so that it can be performed in a simple manner.

Further, the heat treatment time is not specifically limited, but from the view point of sufficiently removing the excessive moisture in the composite hydroxide, it is preferable to be at least 1 hour, more preferably 5 hours to 15 hours.

(4-2) Mixing Process

The mixing process is a process where a lithium mixture is obtained by mixing a lithium compound to the composite hydroxide or heat-treated particles.

In the mixing process, it is required to mix the composite hydroxide or heat-treated particles and the lithium compound so that the ratio (Li/Me) of the sum (Me) of the number of atoms of metal atoms other than lithium, specifically, nickel, cobalt, manganese, and the added element M and the number of atoms (Li) of lithium becomes 0.95 to 1.5, preferably 1.0 to 1.5, more preferably 1.0 to 1.35, even more preferably 1.0 to 1.2. That is, the value of Li/Me does not change before and after the calcination process, so it is required to mix the composite hydroxide or heat-treated particles and the lithium compound so that the value of Li/Me in the mixing process becomes the value of Li/Me of aimed positive electrode active material.

The lithium compound used in the mixing process is not specifically limited, but from its easy availability, it is preferable to use lithium hydroxide, lithium nitrate, lithium carbonate, or a mixture of these. Especially, when ease of handling and quality stability is considered, it is preferable to use lithium hydroxide or lithium carbonate.

The composite hydroxide or the heat-treated particles and the lithium compound are preferred to be sufficiently mixed to the extent that fine powders do not occur. For example, it is possible to use a shaker mixer, a Loedige mixer, a Julia mixer, a V blender, and the like.

(4-3) Temporary Calcination Process

When lithium hydroxide and lithium carbonate are used as a lithium compound, a temporary calcination process may be performed after the mixing process and before the calcination process to temporarily calcine the lithium mixture at a low temperature that is lower than the calcination temperature that is 350° C. to 800° C., preferably 450° C. to 780° C. By doing this, it is possible to sufficiently disperse lithium in the composite hydroxide of the heat-treated particles so as to obtain more uniform positive electrode active material.

The retention time at the above temperature is preferably 1 hour to 10 hours, more preferably 3 hours to 6 hours. Further, the atmosphere in the temporary calcination process is preferably to be an oxidizing atmosphere as similar to the calcination process that will be explained later, and the oxygen concentration is preferably 18 volume % to 100 volume %.

(4-4) Calcination Process

A calcination process is a process where a positive electrode active material is obtained by calcining the lithium mixture that was obtained in the mixing process under a predetermined condition, then dispersing lithium in the composite hydroxide or the heat-treated particles.

As the center section in the composite hydroxide or the heat-treated particles has a structure having a lot of gaps where fine primary particles are continuous, so that the calcination proceeds from the low temperature area in the center section and the center section shrinks toward the high density layer side where the calcination is slow so as to form an internal space having a predetermined size in the center section of the secondary particles.

The high density layer and the outer shell layer (or the first high density layer, the second high density layer and the outer shell layer) of the composite hydroxide and the heat-treated particles causes sintering shrinkage and substantially be integrated to form a primary particle aggregates in one outer shell section in the positive electrode active material.

On the other hand, the low density layer is formed to include the fine primary particles, so similar to the center section, calcination initiates at a lower temperature area in the low density layer compared to the high density layer and the outer shell layer. When doing this, the low density layer has a larger volume shrinkage amount compared to that of the high density layer and the outer shell layer, so the fine primary particles of the low density layer causes volume shrinkage in the direction towards the high density layer and the outer shell layer where the calcination proceeds slowly, gaps having a suitable size are formed between the high density layer and the outer shell layer, or between the first high density layer and the second high density layer and between the second high density layer and the outer shell layer. As these gaps do not comprise a thickness in the radial direction so as to maintain its shape, they are absorbed into the high density layer and the outer shell layer as calcination of the high density layer and the outer shell layer proceeds and since the absorbed volume is not compensated, as the high density layer and the outer shell layer shrink and integrate during calcination, a through-hole that communicates the internal space and the outside of the secondary particles is formed in the formed outer shell section of the positive electrode active material. The section between the high density layer and the outer shell section (or the section between the first high density layer and the second high density layer and the section between the second high density layer and the outer shell section) is electrically conductive as an outer shell section as a whole by integration due to sintering shrinkage.

As stated above, in the positive electrode active material of the present invention, the whole outer sell section is electrically conductive and the cross-sectional area of its conduction path is sufficiently secured. As a result, it becomes possible to use the internal and external surfaces of the positive electrode active material as an integrated outer shell section, and the internal resistance of the positive electrode active material largely decreases and it becomes possible to improve the output characteristics without deteriorating the battery capacity and the cycling characteristics when the secondary battery if formed.

Such particle structure of a positive electrode active material is basically determined based on the particle structure of the composite hydroxide which is a precursor, but as it may be effected by its composition and a calcination condition, it is preferable to suitably adjust each condition by performing a preliminary test so as to obtain a desired structure.

The furnace used for the calcination process is not specifically limited as long as it is able to calcine a lithium mixture in the air atmosphere or oxygen stream. However, from the viewpoint of maintaining the atmosphere in the furnace uniform, it is preferable to use an electric furnace that does not cause gas, and either batch or continuous type of electric furnace can be suitably used. This is the same for the furnace used for the heat-treating process and the temporary calcination process.

a) Calcination Temperature

The calcination temperature of a lithium mixture is required to be 650° C. to 1000° C. When the calcination temperature is less than 650° C., lithium does not disperse in the composite hydroxide or the heat-treated particles so there may be a case where excess lithium or unreacted composite hydroxide or heat-treated particles remain, or the crystallinity of the obtained positive electrode active material may be insufficient. On the other hand, when the calcination temperature is higher than 1000° C., intense sintering occurs between the particles of the positive electrode active material and abnormal grain growth is caused, leading the ratio of irregular large particles to increase.

The rate at which temperature rises in the calcination process is preferably 2° C./minute to 10° C./minute, more preferably 5° C./minute to 10° C./minute. Further, during the calcination process, it is preferable to retain the temperature around the melting point of the lithium compound for preferably 1 hour to 5 hours, more preferably 2 hours to 5 hours. By doing this, it is possible to more uniformly react the composite hydroxide or the heat-treated particles and lithium compound.

b) Calcination Time

Of the calcination time, the retention time at the calcination temperature is preferably at least 2 hours, and more preferably 4 hours to 24 hours. When the retention time at the calcination temperature is less than 2 hours, lithium is not sufficiently dispersed in the composite hydroxide or the heat-treated particles and excess lithium and unreacted composite hydroxide or heat-treated particles remain, and there may be a probability that the crystallinity of the obtained positive electrode active material may be insufficient.

After the termination of the retention time, the cooling rate of the temperature from the calcination temperature to at least 200° C. is preferably 2° C./minute to 10° C./minute, more preferably 33° C./minute to 77° C./minute. By controlling the cooling rate to be within such ranges, it becomes possible to protect facilities such as a sagger from damage caused by quenching while securing productivity.

c) Calcination Atmosphere

The atmosphere at calcination is preferably an oxidizing atmosphere, and it is more preferable to make the atmosphere having the oxygen concentration of 18 volume %6 to 100 volume %, and it is especially preferable to make the atmosphere a mixed atmosphere of oxygen at the above oxygen concentration and inert gas. That is, it is preferable to perform calcination in the air or oxygen stream. When the oxygen concentration is less than 18 volume %, there may be a probability that the crystallinity of the positive electrode active material may be insufficient.

(4-5) Crushing Process

There may be a case where aggregation or mild sintering is caused in the positive electrode active material that was obtained by the calcination process. In such a case, it is preferable to physically crush the aggregate or the sintered body of the positive electrode active material. By doing this, it is possible to adjust the average particle size and particle size distribution of the obtained positive electrode active material to be within a suitable range. Here, crushing means an operation to loosen the aggregates by applying mechanical energy to the aggregates of a plurality of secondary particles that were caused at calcination by sintering necking between the secondary particles and the like so as to separate the secondary particles themselves almost without destroying.

A known method can be used as a method of crushing, and a pin mill and hammer mill and the like can be used. When crushing, it is preferable to adjust the power of crushing in a suitable range so as not to destroy the secondary particles.

5. Non-Aqueous Electrolyte Secondary Battery

The non-aqueous electrolyte secondary battery of the present invention comprise component members such as positive electrode, negative electrode, separator, non-aqueous electrolyte that are similar to that of general non-aqueous electrolyte secondary battery. The embodiments explained below are only examples, and the non-aqueous electrolyte secondary battery of the present invention can be applied to embodiments to which various changes are made or improved embodiments based on the embodiments described in this specification.

(5-1) Component Members

a) Positive Electrode

For example, by using the positive electrode active material of the present invention, a positive electrode of a non-aqueous electrolyte secondary battery is manufactured as follows.

First, a conductive material and an bonding agent are mixed to the positive electrode active material of the present invention, and an activated carbon and a solvent such as a viscosity adjustment is added if further needed to prepare a mixed positive electrode paste by kneading. When doing this, the mixing ratio of each element in the mixed positive electrode paste becomes an important factor that determines the properties of the non-aqueous electrolyte secondary battery. For example, when the solid portion of the positive electrode material without the solvent is taken to be 100 parts by mass, then, as in the case of a general positive electrode of a non-aqueous electrolyte secondary battery, the amount of positive electrode active material that is included is taken to be 60 parts by mass to 95 parts by mass, the amount of conductive material that is included is taken to be 1 part by mass to 20 parts by mass, and the amount of bonding agent included is taken to be 1 part by mass to 20 parts by mass.

The obtained mixed positive electrode paste is applied, for example, to the surface of a collector made of aluminum foil, and then dried to release the solvent. As necessary, in order to increase the electrode density, pressure may be applied using a roll press. In this way, it is possible to produce a sheet-type positive electrode. A sheet-type positive electrode can be cut to an appropriate size to correspond to the target battery, and provided for producing a battery. Here, the method for producing a positive electrode is not limited to the example described above, and other methods can also be used.

As the electrically conductive material, it is possible to use, for example, graphite (natural graphite, artificial graphite, expanded graphite and the like), or carbon black such as acetylene black or Ketjen black.

The binding agent performs the role of binding together active material particles, and, for example, it is possible to use polyvinylidene fluoride (PVDF), polytetrafluoroethylene (PTFE), fluororubber, ethylene propylene diene rubber, styrene-butadiene, cellulose resin, and polyacrylic acid.

Moreover, it is possible to add a solvent to the positive electrode material to disperse the positive electrode active material, electrically conductive material and active carbon, and to dissolve the binding agent. As the solvent, it is possible to use an organic solvent such as N-methyl-2-pyrrolidone. It is also possible to add active carbon to the positive electrode material for increasing the electric double-layer capacitance.

b) Negative Electrode

Metallic lithium or lithium alloy and the like can be used for a negative electrode. Further, it is possible to use a structure as the negative electrode, the structure obtained by mixing a binding agent to an negative electrode active material capable of insertion/de-insertion of lithium ions and adding a suitable solvent to form a paste-like negative electrode material, then applying that negative electrode material to the surface of a metal foil current collector, for example, copper foil current collector, drying the material, and pressing as necessary to increase the electrode density.

As the negative electrode active material, it is possible to use, for example, a substance that includes lithium such as metal lithium or lithium alloy, a substance capable of insertion/de-insertion of lithium ions such as natural graphite, artificial graphite, and calcined body of organic compound such as phenol resin, as well as a powdered carbon material such as coke. In this case, as in the case of the positive electrode, it is possible to use a fluorine-containing resin such as PVDF as the negative electrode binding agent, and as the solvent for dispersing the active material and binding agent, an organic solvent such as N-methyl-2-pyrrolidone can be used.

c) Separator

A separator is arranged so as to be held between the positive electrode and the negative electrode. The separator has a function that separates the positive electrode and the negative electrode and retains the non-aqueous electrolyte. As for such a separator, it is possible to use a thin film such as polyethylene and polypropylene or the like that has many small minute holes. However, it is not specifically limited as long as the separator has the above functions.

d) Non-Aqueous Electrolyte

As for the non-aqueous electrolyte, other than a non-aqueous electrolyte that dissolves lithium salt which is a supporting electrolyte in an organic solvent, solid electrolyte which is nonflammable and has ion conductivity is used.

Among these, as for the organic solvent that is used for the non-aqueous electrolyte, it is possible to use one kind or a combination of two kinds or more selected from among:

a cyclic carbonate such as ethylene carbonate, propylene carbonate, butylene carbonate, trifluoro propylene carbonate and the like;

a chain carbonate such as diethyl carbonate, dimethyl carbonate, ethyl methyl carbonate, dipropyl carbonate and the like;

an ether compound such as tetrahydrofuran, 2-methyltetrahydrofuran, dimethoxyethane and the like;

a sulfur compound such as ethyl methyl sulfone, butane sulfone and the like; and

a phosphorus compound such as triethyl phosphate, trioctyl phosphate and the like.

As the supporting electrolyte, it is possible to use LiPF₆, LiBF₄, LiClO₄, LiAsF₆, LiN(CF₃SO₂)₂, a composite salt of these and the like.

Here, the non-aqueous electrolyte can also include a radical scavenger, a surfactant, flame retardant and the like.

On the other hand, as for the solid electrolyte, it is possible to use Li_{1.3}Al_{0.3}T_{1.7} (PO₄)₃, Li₂S—SiS₂, and the like.

(5-2) Construction

The non-aqueous electrolyte secondary battery of the present invention that is formed from the positive electrode, negative electrode, separator and non-aqueous electrolyte as described above can have various shapes such as a cylindrical shape, a layered shape and the like.

No matter what shape is used, for example, the positive electrode and negative electrode are layered with a separator in between to form an electrode body, and the electrolyte is impregnated into the obtained electrode body, collector leads are used to connect between the positive electrode current collector and a positive electrode terminal that runs to the outside, and between the negative electrode current collector and an negative electrode terminal that runs to the outside, and the components are then sealed in a battery case to complete the non-aqueous electrolyte secondary battery.

(5-3) Characteristics

As described above, the non-aqueous electrolyte secondary battery of the present invention uses the positive electrode active material of the present invention as the positive electrode material, so its battery capacity and cycling characteristics are excellent and the output characteristics has been greatly improved compared to that of the conventional construction. Further, compared to a secondary battery using a positive electrode active material that is composed of conventional lithium-nickel-based composite oxide, its thermal stability and safety are not inferior.

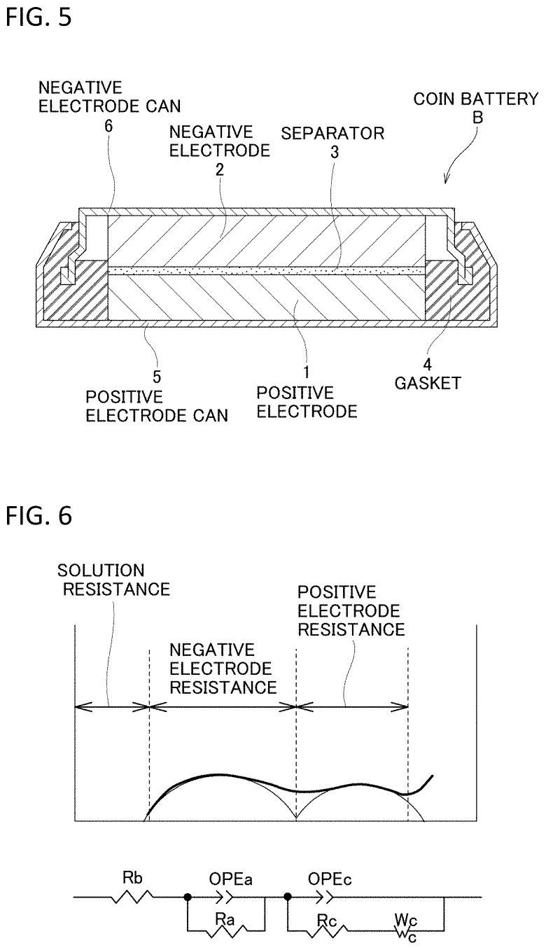

For example, when a 2032 type coin battery such as illustrated in FIG. 5 is made using the positive electrode active material of the present invention, it is possible to simultaneously achieve initial discharge capacity of 150 mAh/g or more, preferably 158 mAh/g or more; positive electrode resistance of 1.10Ω or less, preferably 1.00Ω or less; and 500 cycle capacity retention rate of 75% or more, preferably 80% or more.

(5-4) Uses

As stated above, the non-aqueous electrolyte secondary battery of the present invention has excellent battery capacity, output characteristics, and cycling characteristics, and it is suitably used as the power source for compact mobile electronic devices such as laptop computers and mobile phones for which these characteristics are required at a high level. Further, among these characteristics, the output characteristics of the non-aqueous electrolyte secondary battery of the present invention has been greatly improved and its safety is excellent as well, so that not only it is possible to be miniaturized and capable of high output, but also possible to simplify the expensive protection circuits, and therefore it can be suitably used as the power source for transport machinery in which installation space is limited.

### EXAMPLES

In the following, the present invention will be described in detail by referencing some examples and comparative examples. These are only examples of the embodiments of the present invention, and the present invention shall not be limited by these contents. In all of the examples and comparative examples, unless specified otherwise, specimens using special high-grade chemicals manufactured by Wako Pure Chemicals Industry, Ltd. were used for making the positive electrode active material. Further, during the nucleation step and the particle growth step, the pH value of the reaction aqueous solution was measured with a pH controller (manufactured by Nisshinrika Ltd., NPH-690D) and supply of the sodium hydroxide aqueous solution was adjusted based on this measured value so as to control the pH value of the reaction aqueous solution in each step is within a range of 0.2 with respect to the set values of the steps.

### Example 1

a) Manufacturing Transition Metal Composite Hydroxide

[Nucleation Step]

First, 1.4 L of water was put into a reaction tank (6 L) while stirring, the temperature inside the tank was set to 70° C. When doing this, nitrogen gas was communicated for 30 minutes in the reaction tank so as to make the oxygen concentration in the internal space of the reaction tank to be 1 volume % or less. After that, suitable amount of 25% by mass sodium hydroxide aqueous solution was supplied to the reaction tank to prepare a pre-reaction aqueous solution by adjusting the pH value to be 13.1 at a standard solution temperature of 25′C.

At the same time, nickel sulfate, cobalt sulfate, manganese sulfate, and zirconium sulfate were dissolved to water so that the molar ratio of each metal element becomes Ni:Mn:Co:Zr=33.1:33.1:33.1:0.2 to prepare a raw material aqueous solution of 2 mol/L.

Next, this raw material aqueous solution was supplied to the pre-reaction aqueous solution at a flow rate of 10 ml/minute to prepare a reaction aqueous solution, and nucleation was performed for 3 minutes by crystallization reaction. During this treatment, 25% by mass sodium hydroxide aqueous solution was supplied at a suitable timing to maintain the pH value of the reaction aqueous solution within the above range.

[Particle Growth Step]

After the nucleation step, the supply of all of the aqueous solution to the reaction tank was suspended and 37% by mass sulfuric acid was added to the reaction tank so as to make the pH value of the reaction aqueous solution to be 11.8 at a standard solution temperature of 25′C. After checking that the pH value became a predetermined value, the raw material aqueous solution and sodium tungstate aqueous solution were supplied to grow the nuclei produced in the nucleation step.

After 7 minutes passed from the initiation of the particle growth step (2.9% with respect to the entire time for the particle growth step), while continuing the supply of the raw material aqueous solution, the 37% by mass sulfuric acid was added into the reaction tank so as to adjust the pH value of the reaction aqueous solution to be 11.0 at a standard solution temperature of 25° C. (switching operation 1).

After passing 150 minutes from the initiation of the switching operation 1 (62.5% with respect to the entire time for the particle growth step), while continuing the supply of the raw material aqueous solution, the 25% by mass sodium hydroxide aqueous solution is added into the reaction tank so as to adjust the pH value of the reaction aqueous solution to be 11.8 at a standard solution temperature of 25° C. (switching operation 2).

After passing 20 minutes from the initiation of the switching operation 2 (8.3% with respect to the entire time for the particle growth step), the switching operation 1 was performed again.

After passing 63 minutes from the initiation of the switching operation 1 (26.3% with respect to the entire time for the particle growth step), the supply of all the aqueous solution into the reaction tank was stopped to terminate the particle growth step. In the particle growth step, 25% by mass sodium hydroxide aqueous solution was supplied at a suitable timing to maintain the pH value of the reaction aqueous solution in said range.

At the termination of the particle growth step, the concentration of the product in the reaction aqueous solution was 86 g/L. After that, by washing, filtering, and drying the obtained the product, a powder composite hydroxide was obtained.

b) Evaluation of Composite Hydroxide

[Composition]

This composite hydroxide is made as a sample and its element fractions were measured by using an ICP atomic emission spectrometry device (ICPE-9000 manufactured by Shimadzu Corporation), it was confirmed that this composite hydroxide is expressed by a general formula: Ni_{0.331}Mn_{0.331}Co_{0.331}Zr_{0.002}W_{0.005} (OH)₂.

[Average Particle Size and Particle Size Distribution]

By using a laser beam diffraction scattering particle size analyzer (Microtrac HRA, manufactured by Nikkiso Co., Ltd) to measure the average particle size of the secondary particles of the composite hydroxide as well as to measure the d10 and d90, the value of [(d90-d10)/average particle size] which is an index that indicates the spread of the particle size distribution was calculated. As a result, the average particle size of the composite hydroxide was 5.1 μm and the value of [(d90-d10)/average particle size] was 0.42.

c) Manufacturing Positive Electrode Active Material

The heat-treating process was performed to the obtained composite hydroxide and heat treatment was performed in the air stream (oxygen concentration: 21 volume %) at 120° C. for 12 hours to obtain heat-treated particles. After that, as a mixing process, the heat-treated particles and lithium carbonate were mixed so that the value of Li/Me becomes 1.14, and a lithium mixture was obtained by sufficiently mixing by using a shaker mixer (TURBULA Type T2C, manufactured by Willy A Bachofen (WAB) AG).

Next, the calcination process was performed to this lithium mixture in the air stream (oxygen concentration: 21 volume %) while the rate of temperature rise was set to be 2.5° C./minute to raise the temperature from the room temperature to 950° C. and the temperature was retained for 4 hours to perform calcination, and it was cooled to the room temperature at the cooling rate of 4° C./minute. In the positive electrode active material that was obtained like this, aggregation or mild sintering were occurred, so a crushing process was performed to crush this positive electrode active material and the average particle size and particle size distribution were adjusted.

d) Evaluation of Positive Electrode Active Material

[Composition]

This positive electrode active material was made as a sample and its element fractions were measured by using the ICP atomic emission spectrometry device, it was confirmed that this positive electrode active material is expressed by a general formula: Li_{1.14}Ni_{0.331}Mn_{0.331}Co_{0.331}Zr_{0.002}W_{0.005}O₂.

[Average Particle Size and Particle Size Distribution]

By using a laser beam diffraction scattering particle size analyzer, the average particle size, the d10 and d90 of this positive electrode active material was measured, the value of [(d90-d10)/average particle size] which is an index that indicates the spread of the particle size distribution was calculated. As a result, the average particle size of the positive electrode active material was 5.3 μm and the value of [(d90-d10)/average particle size] was 0.43.

[Particle Structure]

By observing the positive electrode active material with the FE-SEM (see FIG. 1), it was confirmed that this positive electrode active material was nearly spherical and was formed from secondary particles having an almost uniform particle size. Further, part of the positive electrode active material was embedded in a resin and made its cross sections of the particles to be observed with a cross section polisher processing (see FIG. 2). As a result, it was found that this positive electrode active material was formed from nearly spherical secondary particles, and the secondary particles were hollow particles having an internal space (the center section of hollow space structure) in the center of the secondary particles with an outer shell section arranged outside the internal space in substantially spherical shell shape. The outer shell section ratio to particle size was 18%. Further, from the surface observation of the particles in which the internal space that exist in the center section of the secondary particles and the outside communicates through the outer shell section, through-holes that communicate the internal space that exists in the center section of the secondary particles and the outside were found in the outer shell section in 6.5% of the number of secondary particles that are able to observe the entire particle. Furthermore, from the cross-section observation of the particles, the inner diameter of the through-hole (average inner diameter) was 0.5 μm and the through-hole inner diameter ratio to outer-shell section was 0.52.

[Specific Surface Area, Tap Density, and Specific Surface Area per Unit Volume]

By making this positive electrode active material as a sample, the specific surface area was measured with flow system gas absorption method specific surface area measurement device (manufactured by Yuasa Ionics, Inc., multi-sorb), and the tap density was measured with tapping machine (manufactured by Kuramochikagaku Corporation, KRS-406). As a result, the BET specific surface area of this positive electrode active material was 1.51 m²/g and the tap density was 1.53 g/cm³. Further, the specific surface area per unit volume that was obtained from these measured values was 2.31 m²/cm³.

e) Manufacturing Secondary Battery

52.5 mg of the positive electrode active material that was obtained as stated above, 15 mg of acetylene black, and 7.5 mg of PTEE were mixed and pressed at 100 MPa to press-form the mixture so as to have a diameter of 11 mm and a thickness of 100 μm, a positive electrode (1) was formed by drying at 120° C. for 12 hours in a vacuum dryer.

Then, this positive electrode (1) was used to form a 2032 type coin cell (B) that is illustrated in FIG. 5 in a globe box of an argon (Ar) atmosphere where the dew point was controlled to be −80° C. Lithium metal having a diameter of 17 mm and a thickness of 1 mm is used for the negative electrode (2) of this 2032 type coin cell, and an equal amount mixture (manufactured by Tomiyama Pure Chemical Industries, Ltd.) of ethylene carbonate (EC) and diethyl carbonate (DEC) having 1M of LiClO₄ as a supporting electrolyte was used for the electrolyte. A polyethylene porous membrane having a thickness of 25 μm was used as the separator (3). Here, the 2032 type coin cell (B) had a gasket (4) and was assembled as a coin-shaped battery with a positive electrode can (5) and an negative electrode can (6).

f) Battery Evaluation

[Initial Discharge Capacity]

After leaving it for about 24 hours from the formation of the 2032 type coin cell and the open circuit voltage became stable, the battery was charged at a current density of 0.1 mA/cm² with respect to the positive electrode until the cut-off voltage becomes 4.3 V. After a pause of 1 hour, a charge/discharge test was performed to measure the discharge capacity when discharged until the cut-off voltage became 3.0 V so as to obtain the initial discharge capacity. As a result, the initial discharge capacity was 159.4 mAh/g. For the measurement of the initial discharge capacity, a multi-channel voltage/current generator (manufactured by Advantest Corporation, R6741A) was used.

[Positive Electrode Resistance]

Resistance value was measured by AC impedance method using the 2032 type coin cell that was charged at a charging potential of 4.1 V. A frequency response analyzer and potentiogalvanostat (manufactured by Solartron) were used for the measurement to obtain the nyquist plot illustrated in FIG. 6. The plot was indicated as a sum of the solution resistance, negative electrode resistance and capacity, and a characteristic curve indicating the positive electrode resistance and capacity, so fitting calculation was performed by using an equivalent circuit to calculate the value of the positive electrode resistance. As a result, the positive electrode resistance was 1.035Ω.

[Cycling Characteristics]

By repeating the charge/discharge test and measuring the 500^{th} discharge capacity, 500 cycle capacity retention rate was calculated. As a result, the 500 cycle capacity retention rate was confirmed to be 82.1%.

The manufacturing conditions of the above transition metal composite hydroxide and positive electrode active material and its characteristics, and the capacities of the battery using them are shown in Table 1 through Table 4. The results of the following Example 2 through Example 18, Comparative Example 1 through Comparative Example 9 are shown in Table 1 through Table 4 as well.

### Example 2

In the particle growth step, the switching operation 1 was performed after 7 minutes passed from the initiation of the particle growth step (2.9% with respect to the entire time for the particle growth step) and the switching operation 2 was performed after 96 minutes from the switching operation 1 (39.5% with respect to the entire time for the particle growth step), after that, the switching operation 1 was performed after 20 minutes from the switching operation 2 (8.2% with respect to the entire time for the particle growth step), and then crystallization reaction for 12 minutes were performed (49.4% with respect to the entire time for the particle growth step). The conditions other than the above were set as similar to Example 1, and composite hydroxide, positive electrode active material, and secondary battery were formed and evaluated as similar to Example 1.

### Example 3

In the particle growth step, the switching operation 1 was performed after 24 minutes from the initiation of the particle growth step (10% with respect to the entire time for the particle growth step) and the switching operation 2 was performed after 150 minutes from the switching operation 1 (62.5% with respect to the entire time for the particle growth step), after that, switching operation 1 was performed after 20 minutes from the switching operation 2 (8.3% with respect to the entire time for the particle growth step), and then crystallization reaction was performed for 46 minutes (19.2% with respect to the entire time for the particle growth step). The conditions other than the above were set as similar to Example 1, and composite hydroxide, positive electrode active material, and secondary battery were formed and evaluated as similar to Example 1.

### Example 4

In the particle growth step, the switching operation 1 was performed after 24 minutes from the initiation of the particle growth step (10% with respect to the entire time for the particle growth step) and the switching operation 2 was performed after 96 minutes from the switching operation 1 (40% with respect to the entire time for the particle growth step), after that, switching operation 1 was performed after 20 minutes from the switching operation 2 (8.3% with respect to the entire time for the particle growth step), and then crystallization reaction was performed for 100 minutes (41.7% with respect to the entire time for the particle growth step). The conditions other than the above were set as similar to Example 1, and composite hydroxide, positive electrode active material, and secondary battery were formed and evaluated as similar to Example 1.

### Example 5

In the particle growth step, the switching operation 1 was performed after 7 minutes from the initiation of the particle growth step (2.9% with respect to the entire time for the particle growth step), after that, the switching operation 2 was performed after 168 minutes from the switching operation (70% with respect to the entire time for the particle growth step), after that, switching operation 1 was performed after 20 minutes from the switching operation 2 (8.3% with respect to the entire time for the particle growth step), and then crystallization reaction was performed for 45 minutes (18.8% with respect to the entire time for the particle growth step). The conditions other than the above were set as similar to Example 1, and composite hydroxide, positive electrode active material, and secondary battery were formed and evaluated as similar to Example 1.

### Example 6

In the particle growth step, the switching operation 1 was performed after 24 minutes from the initiation of the particle growth step (10% with respect to the entire time for the particle growth step), after that, the switching operation 2 was performed after 60 minutes from the switching operation 1(25% with respect to the entire time for the particle growth step), after that, the switching operation 1 was performed after 36 minutes from the switching operation 2 (15% with respect to the entire time for the particle growth step), and then crystallization reaction was performed for 120 minutes (50% with respect to the entire time for the particle growth step). The conditions other than the above were set as similar to Example 1, and transition metal composite hydroxide, positive electrode active material, and secondary battery were formed and evaluated as similar to Example 1.

### Example 7

In the particle growth step, the switching operation 1 was performed after 12 minutes from the initiation of the particle growth step (5% with respect to the entire time for the particle growth step), after that, the switching operation 2 was performed after 144 minutes from the switching operation 1 (60% with respect to the entire time for the particle growth step), after that, the switching operation 1 was performed after 12 minutes from the switching operation 2 (5% with respect to the entire time for the particle growth step), and then crystallization reaction for 72 minutes (30% with respect to the entire time for the particle growth step). The conditions other than the above were set as similar to Example 1, and transition metal composite hydroxide, positive electrode active material, and secondary battery were formed and evaluated as similar to Example 1.

### Example 8

In the particle growth step, the switching operation 1 was performed after 7 minutes from the initiation of the particle growth step (2.9% with respect to the entire time for the particle growth step), after that, the switching operation 2 was performed after 120 minutes from the switching operation 1 (50% with respect to the entire time for the particle growth step), after that, the switching operation 1 was performed after 36 minutes from the switching operation 2 (15% with respect to the entire time for the particle growth step %), and then crystallization reaction was performed for 77 minutes (32.1% with respect to the entire time for the particle growth step). The conditions other than the above were set as similar to Example 1, and transition metal composite hydroxide, positive electrode active material, and secondary battery were formed and evaluated as similar to Example 1.

### Example 9

In the particle growth step, the switching operation 1 was performed after 7 minutes from the initiation of the particle growth step (3% with respect to the entire time for the particle growth step), after that, the switching operation 2 was performed after 120 minutes from the switching operation 1 (52.4% with respect to the entire time for the particle growth step), after that, the switching operation 1 was performed after 18 minutes from the switching operation 2 (7.9% with respect to the entire time for the particle growth step), and then crystallization reaction was performed for 33 minutes (14.4% with respect to the entire time for the particle growth step), further after that, the switching operation 2 was performed after 18 minutes from the switching operation 1 (7.9% with respect to the entire time for the particle growth step), after that, crystallization reaction was continued for 33 minutes from the switching operation 2 (14.4% with respect to the entire time for the particle growth step). The conditions other than the above were set as similar to Example 1, and transition metal composite hydroxide, positive electrode active material, and secondary battery were formed and evaluated as similar to Example 1.

### Comparative Example 1

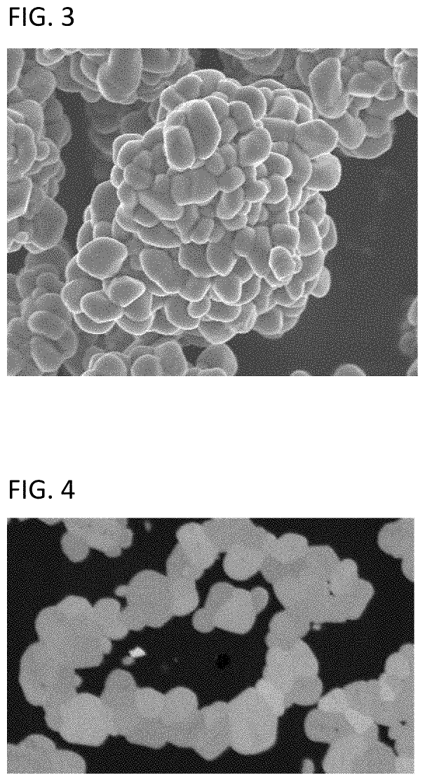

In the particle growth step, the switching operation 1 was performed after 7 minutes from the initiation of the particle growth step (2.9% with respect to the entire time for the particle growth step), and it was continued for 233 minutes (97.1% with respect to the entire time for the particle growth step) until the crystallization reaction is terminated. The conditions other than the above were set as similar to Example 1, composite hydroxide was formed and evaluated as similar to Example 1. FIG. 3 and FIG. 4 illustrates FE-SEM images of the surface and the cross section of the composite hydroxide obtained in Comparative Example 1 and the surface and the cross section of the positive electrode active material. As can be understood from FIG. 4, in the obtained positive electrode active material, the particle structure of its secondary particles was a hollow structure having no through-holes.

### Comparative Example 2

In the particle growth step, the switching operation 1 was performed after 72 minutes from the initiation of the particle growth step (30% with respect to the entire time for the particle growth step), and the switching operation 2 was performed after 120 minutes from the switching operation 1 (50% with respect to the entire time for the particle growth step), after that, the switching operation 1 was performed after 3 minutes from the switching operation 2 (1.25% with respect to the entire time for the particle growth step), and then crystallization reaction was performed for 45 minutes (18.75% with respect to the entire time for the particle growth step), The conditions other than the above were set as similar to Example 1, and transition metal composite hydroxide, positive electrode active material and secondary battery were formed and evaluated as similar to Example 1. Here, in the obtained positive electrode active material, the particle structure of its secondary particles was a hollow structure having no through-holes.

### Comparative Example 3

In the particle growth step, the switching operation 1 was performed after 7 minutes from the initiation of the particle growth step (2.9% with respect to the entire time for the particle growth step), after that, the switching operation 2 was performed after 96 minutes (40% with respect to the entire time for the particle growth step) from the switching operation 1, after that, the switching operation 1 was performed after 96 minutes from the switching operation 2 (40% with respect to the entire time for the particle growth step), and then crystallization reaction was performed for 41 minutes (17.1% with respect to the entire time for the particle growth step). The conditions other than the above were set as similar to Example 1, and transition metal composite hydroxide, positive electrode active material and secondary battery were formed and evaluated as similar to Example 1. Here, in the obtained positive electrode active material, the particle structure of its secondary particles was a hollow structure having no through-holes.

### Comparative Example 4

In the particle growth step, the switching operation 1 was performed after 7 minutes from the initiation of the particle growth step (2.9% with respect to the entire time for the particle growth step), after that, the switching operation 2 was performed after 15 minutes from the switching operation 1 (6.3% with respect to the entire time for the particle growth step), after that, the switching operation 1 was performed after 20 minutes from the switching operation 2 (8.3% with respect to the entire time for the particle growth step), and then crystallization reaction was performed for 198 minutes (82.5% with respect to the entire time for the particle growth step), The conditions other than the above were set as similar to Example 1, and transition metal composite hydroxide, positive electrode active material and secondary battery were formed and evaluated as similar to Example 1. Here, in the obtained positive electrode active material, the particle structure of its secondary particles was a hollow structure having no through-holes.

TABLE 1

| | Particle Growth Step (Reaction Time of Each Phase (%)) | | | | | |
|---|---|---|---|---|---|---|
| | Initiation to | Switching | Switching | Switching | Switching | Switching |
| | Switching | Operation | Operation | Operation | Operation | Operation |
| | Operation 1 | 1 to2 | 2 to 1 | 1 to 2 | 1 to 2 | 2 to 1 |
| | 1st Phase | 2nd Phase | 3rd Phase | 4th Phase | 5th Phase | 6th Phase |
| Example 1 | 2.9 | 62.5 | 8.3 | 26.3 | — | — |
| Example 2 | 2.9 | 39.5 | 8.2 | 49.4 | — | — |
| Example 3 | 10 | 62.5 | 8.3 | 19.2 | — | — |
| Example 4 | 10 | 40 | 8.3 | 41.7 | — | — |
| Example 5 | 2.9 | 70 | 8.3 | 18.8 | — | — |
| Example 6 | 10 | 25 | 15 | 50 | — | — |
| Example 7 | 5 | 60 | 5 | 30 | — | — |
| Example 8 | 2.9 | 50 | 15 | 32.1 | — | — |
| Example 9 | 3 | 52.4 | 7.9 | 14.4 | 7.9 | 14.4 |
| CE 1 | 2.9 | 97.1 | — | — | — | — |
| CE 2 | 30 | 50 | 1.25 | 18.75 | — | — |
| CE 3 | 2.9 | 40 | 40 | 17.1 | — | — |
| CE 4 | 2.9 | 6.3 | 8.3 | 82.5 | — | — |

CE: Comparative Example

TABLE 2

Composite Oxide

| | | (d90-d10)/ |
|---|---|---|
| | Average Particle | Average |
| | Size (μm) | Particle Size |
| Example 1 | 5.1 | 0.42 |
| Example 2 | 5.1 | 0.43 |
| Example 3 | 5.2 | 0.42 |
| Example 4 | 5.3 | 0.41 |
| Example 5 | 5.0 | 0.41 |
| Example 6 | 5.4 | 0.4 |
| Example 7 | 5.1 | 0.42 |
| Example 8 | 5.2 | 0.41 |
| Example 9 | 5 | 0.4 |
| CE 1 | 4.6 | 0.41 |
| CE 2 | 5.1 | 0.48 |
| CE 3 | 5.0 | 0.46 |
| CE 4 | 5.0 | 0.45 |

TABLE 3

| | Positive electrode Active Material | | | | | |
|---|---|---|---|---|---|---|
| | | | | | | Through- |
| | | | | Outer Shell | Through-Hole | Hole Inner |
| | | | | Section | Average | Diameter |
| | | Average | (d90-d10)/ | Ratio to | Inner | Ratio to |
| | Particle | Particle Size | Average | Particle Size | Diameter | Outer Shell |
| | Structure | (μm) | Particle Size | (%) | (μm) | Section |
| Example 1 | Hollow/ | 5.3 | 0.43 | 18 | 0.5 | 0.52 |
| | Through-Hole | | | | | |
| Example 2 | Hollow/ | 5.2 | 0.43 | 19 | 0.6 | 0.61 |
| | Through-Hole | | | | | |
| Example 3 | Hollow/ | 5.2 | 0.41 | 13 | 0.7 | 1.04 |
| | Through-Hole | | | | | |
| Example 4 | Hollow/ | 5.4 | 0.40 | 15 | 0.5 | 0.62 |
| | Through-Hole | | | | | |
| Example 5 | Hollow/ | 5.2 | 0.42 | 11 | 0.4 | 0.70 |
| | Through-Hole | | | | | |
| Example 6 | Hollow/ | 5.5 | 0.41 | 12 | 0.6 | 0.91 |
| | Through-Hole | | | | | |
| Example 7 | Hollow/ | 5.2 | 0.44 | 14 | 0.5 | 0.67 |
| | Through-Hole | | | | | |
| Example 8 | Hollow/ | 5.2 | 0.43 | 11 | 0.7 | 1.22 |
| | Through-Hole | | | | | |
| Example 9 | Hollow/ | 5.2 | 0.41 | 14 | 0.5 | 0.69 |
| | Through-Hole | | | | | |
| CE 1 | Hollow | 4.8 | 0.40 | 16 | — | — |
| CE 2 | Hollow | 5.3 | 0.48 | 14 | — | — |
| CE 3 | Hollow | 5.1 | 0.47 | 17 | — | — |
| CE 4 | Hollow | 5.2 | 0.45 | 14 | — | — |

TABLE 4

| | Positive electrode Active Material | | | | | |
|---|---|---|---|---|---|---|
| | | | Specific Surface | Initial | Positive | |
| | BET Specific | Tap | Area per Unit | Discharge | electrode | Capacity |
| | Surface Area | Density | Volume | Capacity | Resistance | Retention |
| | (m²/g) | (g/cm³) | (m²/cm³) | (mAh/g) | (Ω) | Rate (%) |
| Example 1 | 1.51 | 1.53 | 2.31 | 159.4 | 1.035 | 82.1 |
| Example 2 | 1.50 | 1.58 | 2.37 | 158.5 | 1.016 | 81.4 |
| Example 3 | 1.65 | 1.44 | 2.38 | 158.1 | 0.992 | 82.0 |
| Example 4 | 1.50 | 1.35 | 2.03 | 158.2 | 0.927 | 81.5 |
| Example 5 | 1.38 | 1.54 | 2.13 | 158.1 | 1.058 | 80.2 |
| Example 6 | 1.75 | 1.43 | 2.50 | 158.5 | 0.988 | 82.1 |
| Example 7 | 1.55 | 1.38 | 2.11 | 158.3 | 0.992 | 81.5 |
| Example 8 | 1.53 | 1.35 | 2.07 | 158.3 | 0.987 | 81.1 |
| Example 9 | 1.36 | 1.59 | 2.16 | 158.1 | 1.035 | 80.5 |
| CE 1 | 1.20 | 1.50 | 1.80 | 158.5 | 1.319 | 80.1 |
| CE 2 | 1.31 | 1.46 | 1.91 | 157.8 | 1.326 | 80.0 |
| CE 3 | 1.24 | 1.45 | 1.80 | 158.1 | 1.305 | 80.1 |
| CE 4 | 1.20 | 1.47 | 1.76 | 157.9 | 1.318 | 80.2 |

### EXPLANATION OF REFERENCE NUMBERS

1 Positive electrode (Electrode for Evaluation)
58
2 Negative electrode
3 Separator
4 Gasket
5 Positive electrode Can
6 Negative electrode Can
B 2032 Type Coin Cell

1. A positive electrode active material for a non-aqueous electrolyte secondary battery comprising a lithium transition metal-containing composite oxide that is expressed by a general formula: Li₁₊ᵤNiₓMn_{y}Co_{z}MtO₂, where −0.05≤u≤0.50, x+y+z+t=1, 0.3≤x≤0.7, 0.05≤y≤0.55, 0≤z≤0.55, 0≤t≤0.1, and M is one or more kind of added element selected from Mg, Ca, Al, Ti, V, Cr, Zr, Nb, Mo, Hf, Ta, and W,
the lithium transition metal-containing composite oxide comprising secondary particles that are constructed by an aggregation of a plurality of primary particles,
the secondary particles comprising an outer shell section where the primary particles are aggregated, a center section constructed by an inner space that exists inside the outer shell section, and at least one through-hole that is formed in the outer shell section and communicates the center section and outside, and a ratio of the inner diameter of the through-hole with respect to the thickness of the outer shell section is 0.3 or more.

2. The positive electrode active material for a non-aqueous electrolyte secondary battery according to claim 1, wherein the thickness ratio of the outer shell section with respect to the particle size of the secondary particles is within a range of 5% to 40%.

3. The positive electrode active material for a non-aqueous electrolyte secondary battery according to claim 1, wherein the average inner diameter of the through-hole is within a range of 0.2 μm to 1.0 μm.

4. The positive electrode active material for a non-aqueous electrolyte secondary battery according to claim 1, wherein the through-hole that is formed in the outer shell section exists in a range of 1 to 5 per one secondary particle.

5. The positive electrode active material for a non-aqueous electrolyte secondary battery according to claim 1, wherein the average particle size of the secondary particles is within a range of 1 μm to 15 μm, and a value of [(d90−d10)/average particle size], which is an index that represents the spread of the particle size distribution, is 0.70 or less.

6. The positive electrode active material for a non-aqueous electrolyte secondary battery according to claim 1, wherein a surface area per unit volume of the secondary particles is 2.0 m²/cm³ or more.

7. The positive electrode active material for a non-aqueous electrolyte secondary battery according to claim 1, wherein a specific surface area of the secondary particles is within a range of 1.3 m²/g to 4.0 m²/g, and a tap density of the secondary particles is 1.1 g/cm³ or more.

8. A non-aqueous electrolyte secondary battery which comprises a positive electrode, an negative electrode, a separator, and a non-aqueous electrolyte, and includes the positive electrode active material for a non-aqueous electrolyte secondary battery according to claim 1 as a positive electrode material of the positive electrode.
